(19) United States
(12) Patent Application Publication
(10) Pub. No.: US 2025/0322395 A1
(43) Pub. Date: Oct. 16, 2025

(54) REAL-TIME DOCUMENT TYPE DETERMINATION

(71) Applicant: Capital One Services, LLC, McLean, VA (US)

(72) Inventor: Namfon THASANON, Jersey City, NJ (US)

(73) Assignee: Capital One Services, LLC, McLean, VA (US)

(21) Appl. No.: 18/632,605

(22) Filed: Apr. 11, 2024

(51) Int. Cl. G06Q 20/40; G06Q 20/04; G06Q 20/10; G06Q 20/32; G06Q 40/02; G06V 30/41

(52) U.S. Cl. CPC G06Q 20/40; G06Q 20/042; G06Q 20/108; G06Q 20/3223; G06Q 40/02; G06V 30/41

(57) ABSTRACT

A computer implemented method, system, and non-transitory computer-readable device for conducting a document type assessment. In some embodiments, a machine learning (ML) model (e.g., an image classification ML model) may be trained to determine a document type and/or document type acceptability from an image. In some embodiments, the ML model may determine the document type and/or document type acceptability in real-time, within a current customer transaction period before the customer submits a deposit or access request or immediately after in response to the customer submitting the deposit or access request. In some embodiments, document types determined by the ML model may be used to track user patterns and perform a comparison of past user patterns with a current deposit or access attempt, improving security. In some embodiments, document types determined by the ML model may be used to customize validation protocols for images.

### BACKGROUND

As technology evolves, institutions have found ways to make digital document verification more convenient. For example, in the financial industry, mobile banking apps may let you deposit paper checks or other financial instruments from virtually anywhere using a smartphone or tablet. Additionally, institutions may allow remote verification of identification documents to allow access to a service, product, and/or website. However, certain types of documents are sometimes not accepted for remote mobile deposit purposes or identity verification. For example, in the financial industry, money orders may not be accepted for remote mobile deposit. Additionally, certain identity verification processes may require some types of documents (e.g., a passport or license), but reject others (e.g., a birth certificate). It can be difficult to determine, in real-time, whether an image of a document provided by a user depicts a type of a document that is acceptable. This may be because extensive image processing or review by a person may be required to determine document type from an electronic image.

### BRIEF DESCRIPTION OF THE DRAWINGS

The accompanying drawings are incorporated herein and form a part of the specification.

FIG. 1 illustrates an example remote deposit financial instrument capture, according to some embodiments.

FIG. 2 illustrates example remote deposit OCR segmentation, according to some embodiments.

FIG. 3 illustrates an example block diagram of a remote deposit system architecture, according to some embodiments.

FIG. 4 illustrates an example flow diagram of a remote deposit system, according to some embodiments.

FIG. 5 illustrates an example block diagram of a client computing device, according to some embodiments.

FIG. 6 illustrates an example flow diagram of a machine learning (ML) system, according to some embodiments.

FIG. 7 illustrates an example block diagram of a deposit security system, according to some embodiments.

FIG. 8 illustrates an example block diagram of a financial instrument assessment system, according to some embodiments.

FIG. 9 illustrates an example block diagram of a validation system, according to some embodiments.

FIG. 10 illustrates an example flow diagram for a method, according to some embodiments.

FIG. 11 illustrates an example block diagram of a computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method and/or computer program product embodiments, and/or combinations and sub-combinations thereof for implementing a document type determination on a mobile or desktop computing device, which may assist, in real-time, a user electronically presenting or submitting an electronic copy of the document to another party. For example, embodiments disclosed herein describe determining a type of financial instrument (e.g., check, money order) prior to submitting an electronic copy of the financial instrument for deposit at a financial institution. The financial instrument type determination may be used to pre-determine whether a deposit attempt will be denied, before conducting further processing on an image associated with the deposit attempt. Further, the financial instrument type determination may be used to customize validation protocols for the image, thereby increasing the efficiency of validation procedures and reducing unnecessary validation failures. Additionally, customized validation protocols may allow additional types of financial instruments not traditionally accepted for remote deposit to be accepted.

Mobile deposit is a fast, convenient way to deposit funds using a customer's mobile device or laptop. The term customer may refer to a user of a mobile banking application, as described below. As financial technology and digital money management tools continue to evolve, the process has become safer and easier than ever before. Mobile deposit is a way to deposit a financial instrument, e.g., a paper check, through a banking app using a smartphone, tablet, laptop, etc. Currently, mobile deposit allows a bank customer to capture a picture of a financial instrument using, for example, their smartphone or tablet camera and upload it through a mobile banking app running on the mobile device. Deposits commonly include personal, business, or government checks.

Most banks and financial institutions use advanced security features to keep an account safe from fraud during the mobile deposit workflow. For example, security measures may include encryption and device recognition technology. In addition, remote deposit apps may capture financial instrument deposit information without storing the financial instrument images on the customer's mobile device (e.g., smartphone). Mobile deposit may also eliminate or reduce typical check fraud as a thief of the check may not be allowed to subsequently make use of an already electronically deposited check, whether it has cleared or not, as remote deposit systems may provide an alert to the banking institution of a second deposit attempt. In addition, fraud controls may include mobile security alerts, such as mobile security notifications or SMS text alerts, which can assist in uncovering or preventing potentially fraudulent activity.

Currently, computer-based (e.g., laptop) or mobile-based (e.g., mobile device) technology allows a customer to initiate a document uploading process for uploading images or other electronic versions of a document to a backend system (e.g., a document processing system) for various purposes. In some cases, this technology does not or cannot sufficiently assess, prior to upload and/or further processing, whether images of documents will be able to be successfully processed at the backend system. For example, in some cases, this technology does not or cannot assess, prior to upload and/or further processing, whether images of documents depict types of financial instruments that are accepted for remote deposit. Currently, an attempt to deposit an impermissible financial instrument type may be revealed only later, once a full validation process has been attempted, causing increased processing costs and customer frustration due to wait times. Additionally, during the time between providing images for deposit and receiving a notification regarding final acceptance of the deposit, a customer may attempt to take the deposit to another financial institution, causing a potential duplicate presentment fraud issue.

The restrictive approach of current systems is necessitated in certain document upload processes because such processes have automated routines for receiving the images, processing the images, and completing actions associated with the upload of the images. For example, a customer may utilize a mobile deposit application to upload an image of a document associated with a customer account, such as a financial instrument associated with the customer's bank account. Once initiated, the document upload and processing may continue until the image has been processed, either successfully or unsuccessfully, without any further input from the customer. This current approach is problematic because the customer is typically not given any information about the status of the image until after the process has completed, when it is too late to cancel or correct the upload and time and processing costs have been wasted.

These processes are more likely to cause increased error rates, processing costs, and customer frustration. The more accurately technology can determine, prior to upload and/or an OCR processing attempt, whether an image will be acceptable for processing a financial transaction, the more efficient and seamless the customer experience will be, and the fewer system and network resources will be required (such as memory space for storing images, processing time associated with processing invalid images, including OCR processing, and network resources associated with sending and receiving invalid images). For example, accurately predetermining that an image depicts a financial instrument that is an impermissible type may prevent a customer from being required to wait one or more days before receiving that determination and a notice requiring the financial instrument to be deposited in person or by mail. Accordingly, transaction processing delays may be reduced. Further, processing costs at a backend system may be reduced by accurately predetermining financial instrument type, as the backend system may use the financial instrument type information to customize validation protocols, thus making them more efficient. For example, OCR programs may be directed to particular locations in a financial instrument image, based on financial instrument type, making OCR processing more efficient. Additionally, the systems and methods disclosed herein may result in higher rates of acceptable financial instrument types being submitted for deposit (since a customer may be notified up front regarding an attempted submission of an impermissible financial instrument type), leading to a more seamless customer experience and reduced processing costs, both at the customer's computing device and at the bank's backend system.

In some embodiments, acceptability/impermissibility of a document type refers to whether a third party accepts submission of the document type. For example, a website may perform a personal identification check before providing access, and may accept an image of a passport or social security card, but not an image of a driver license or birth certificate.

In some embodiments, acceptability/impermissibility of a financial instrument type refers to whether a bank accepts remote mobile deposits of the financial instrument type. For example, some banks may not accept deposits of money orders via remote mobile deposit. As another example, some banks may not accept deposits of traveler's checks via remote mobile deposit. While some examples are provided, any type of financial instrument is contemplated and whether it is of an acceptable financial instrument type may vary from bank to bank. In some cases, certain types of financial instruments are not accepted for remote deposit by a bank because they confuse validation systems, which are not able to successfully analyze images of such types of financial instruments. This may be because unconventional placement of data fields, color features, and/or lack of fields make processing according to standard validation protocols difficult or sure to fail.

In some embodiments, customized validation protocols as described herein may allow additional types of financial instruments not traditionally accepted for remote deposit to be accepted. For example, in some cases, banks may not accept money orders for remote mobile deposit because they may contain non-standard arrangements of text and/or imagery that makes processing difficult. However, the systems and methods disclosed herein may detect and track features of identified types of financial instruments and customize image analysis based on the features. This may better prepare remote deposit validation systems to successfully process types of financial instruments that historically confuse validation systems. The same concepts may be applied to other document types, such as to documents for personal identification (e.g., passport, driver license, social security card, voter registration, birth certificate, military card, etc.).

The technology described herein in the various embodiments may implement a pre-deposit assessment of an image to determine a financial instrument type and/or financial instrument type acceptability. In some embodiments, the image may be assessed using an ML model operating on a customer's mobile device (e.g., a mobile phone). In some embodiments, the ML model may be trained using supervised or semi-supervised learning, for example, by providing a collection of categorized images (e.g., based on type and/or type acceptability) of financial instruments to an untrained or partially trained model to train a predictive ML model (e.g., a classification model and/or regression model). Upon being provided an image of a financial instrument, the predictive ML model may be configured to provide one or more of a financial instrument type determination, a confidence score indicating a likelihood the financial instrument type determination is correct, a financial instrument type acceptability determination, and a confidence score indicating a likelihood the financial instrument type acceptability determination is correct. Based on any one or more of these, a mobile banking app operating on the customer's mobile device may provide a document acceptance status related to acceptance of the image to the customer via a user interface (UI). Accordingly, the predictive ML model may be able to assess financial instrument images mid-experience. Implementing the technology disclosed herein, a document acceptance status may be rendered on a UI mid-experience.

In some embodiments, the image being assessed may be an image that has been captured by a camera of the customer's mobile device and stored within memory of the mobile device, either in permanent storage or temporary storage such as an image buffer. In some embodiments, the image being assessed may be an image frame that is part of a stream of live or continuously observed imagery. This imagery may be processed continuously, for example, in real-time, using the predictive ML model without first storing an image in permanent memory (or perhaps additionally without storing an image in an image buffer). In such embodiments, the assessment of the image frame may be used to trigger automatic capture and at least temporary storage of the image frame (i.e., no image capture may be allowed if a detected financial instrument type is not an acceptable type). In some embodiments, live camera imagery may be streamed as encoded data configured as a byte array (e.g., as a Byte Array Output Stream object). The byte array may be a group of contiguous (side-by-side) bytes, for example, forming a bitmap image. This local processing solution may eliminate or reduce image storage requirements for image assessment using an ML model.

While described throughout for image assessment performed on the client device, in some embodiments, the image or live stream of imagery may be communicated to one or more remote computing devices or cloud-based systems for performing a remote image assessment, wherein the predictive ML model operates on the one or more remote computing devices or cloud-based systems. In such embodiments, the predictive ML model may still determine a financial instrument type prior to forwarding an image for further processing. In such embodiments, a document acceptance status may also be provided to a customer in real-time via a UI.

ML involves computers discovering how they can perform tasks without being explicitly programmed to do so. ML may include, but is not limited to, artificial intelligence, deep learning, fuzzy learning, supervised learning, unsupervised learning, etc. Machine learning algorithms may build a model based on sample data, known as “training data,” in order to make predictions or decisions without being explicitly programmed to do so. For supervised learning, the computer may be presented with example inputs and their desired outputs and the goal is to learn a general rule that maps inputs to outputs. In another example, for unsupervised learning, no labels may be given to the learning algorithm, leaving it on its own to find structure in its input. Unsupervised learning can be a goal in itself (discovering hidden patterns in data) or a means towards an end (feature learning).

A machine learning engine (e.g., operating on ML platform 329) may use various classifiers to map concepts associated with a specific image capture/deposit process to capture relationships between concepts (e.g., pixel data vs. financial instrument type). The classifier (discriminator) may be trained to distinguish (recognize) variations. Different variations may be classified to ensure no collapse of the classifier and so that variations can be distinguished.

In some embodiments, machine learning models may be trained on a remote machine learning platform (e.g., ML platform 329) using other customer's transactional information (e.g., previously submitted deposit financial instrument images and financial instrument type). In addition, large training sets of the other customer's historical information may be used to normalize prediction data (e.g., not skewed by a single or few occurrences of a data artifact). Thereafter, predictive ML model(s) may assess a specific deposit financial instrument image against the trained predictive model to predict financial instrument type and/or financial instrument type acceptability. In some embodiments, the predictive ML model(s) may be continuously updated as new financial transactions occur.

In some embodiment, a ML engine may continuously change weighting of model inputs to increase accuracy of the predictive ML model(s). For example, weighting of specific data fields may be continuously modified in the model to trend towards greater accuracy, where accuracy is recognized by correct predictions of financial instrument type. Conversely, term weighting that lowers accuracy may be lowered or eliminated.

In some embodiments, the ML engine may operate on, and machine learning models may be trained on, a mobile machine learning platform (e.g., mobile ML platform 310). In such embodiments, the machine learning models may be trained and/or refined using a single customer's transactional information (e.g., previously submitted deposit financial instrument images and financial instrument type).

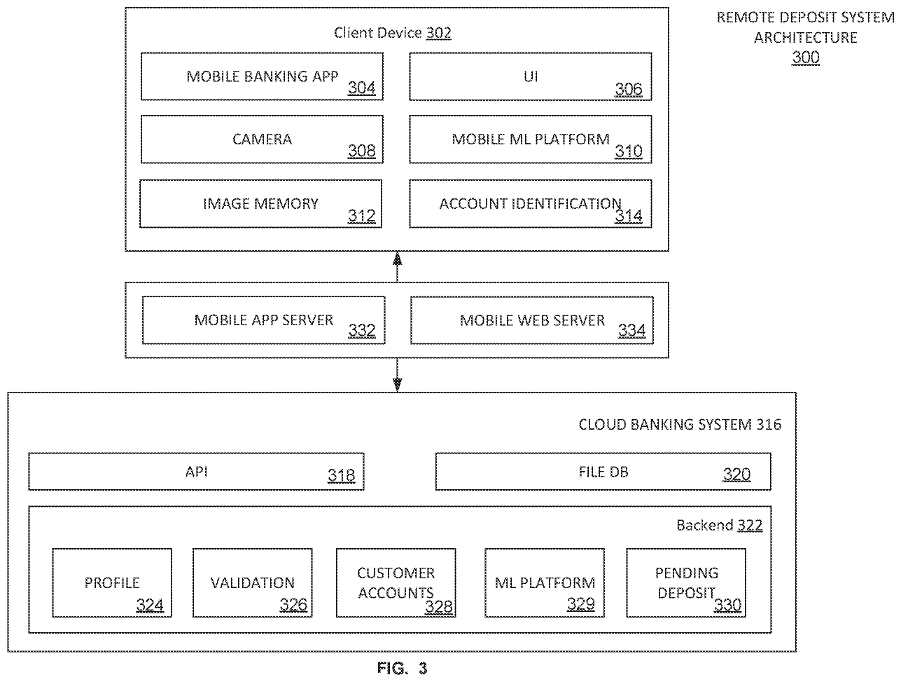

Various embodiments of this disclosure may be implemented using and/or may be part of a remote deposit system shown in FIGS. 3-5. It is noted, however, that this environment is provided solely for illustrative purposes, and is not limiting. Embodiments of this disclosure may be implemented using and/or may be part of environments different from and/or in addition to the remote deposit system, as will be appreciated by persons skilled in the relevant art(s) based on the teachings contained herein.

Variations of the devices disclosed herein are contemplated. For example, in a computing device with a camera, such as a smartphone or tablet, multiple cameras (each of which may have its own image sensor or which may share one or more image sensors) or camera lenses may be implemented to process imagery. For example, a smartphone may implement three cameras, each of which has a lens system and an image sensor. Each image sensor may be the same or the cameras may include different image sensors (e.g., every image sensor is 24 MP; the first camera has a 24 MP image sensor, the second camera has a 24 MP image sensor, and the third camera has a 12 MP image sensor; etc.). In the first camera, a first lens may be dedicated to imaging applications that can benefit from a longer focal length than standard lenses. For example, a telephoto lens generates a narrow field of view and a magnified image. In the second camera, a second lens may be dedicated to imaging applications that can benefit from wide images. For example, a wide lens may include a wider field-of-view to generate imagery with elongated features, while making closer objects appear larger. In the third camera, a third lens may be dedicated to imaging applications that can benefit from an ultra-wide field of view. For example, an ultra-wide lens may generate a field of view that includes a larger portion of an object or objects located within a user's environment. The individual lenses may work separately or in combination to provide a versatile image processing capability for the computing device. While described for three differing cameras or lenses, the number of cameras or lenses may vary, to include duplicate cameras or lenses, without departing from the scope of the technologies disclosed herein. In addition, the focal lengths of the lenses may be varied, the lenses may be grouped in any configuration, and they may be distributed along any surface, for example, a front surface and/or back surface of the computing device.

In one non-limiting example, active OCR processes may benefit from image object builds generated by one or more, or a combination of cameras or lenses. For example, multiple cameras or lenses may separately, or in combination, capture specific blocks of imagery for data fields located within a document that is present, at least in part, within the field of view of the cameras. In another example, multiple cameras or lenses may capture more light than a single camera or lens, resulting in better image quality. In another example, individual lenses, or a combination of lenses, may generate depth data for one or more objects located within a field of view of the camera.

An example of the remote deposit system shall now be described.

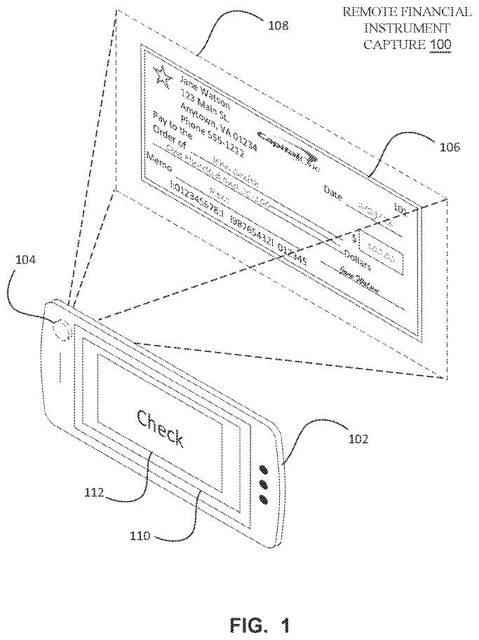

FIG. 1 illustrates an example remote financial instrument capture 100, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 1, as will be understood by a person of ordinary skill in the art.

Financial instrument 106 may be a personal check, a business check, a cashier's check, a certified check, a traveler's check, a treasury check (i.e., a government check), a payroll check, or a money order, to name a few. In some embodiments, a customer may initiate a remote deposit financial instrument capture from their mobile computing device (e.g., smartphone) 102, but other digital camera devices (e.g., tablet computer, personal digital assistant (PDA), desktop workstations, laptop or notebook computers, wearable computers, such as, but not limited to, Head Mounted Displays (HMDs), computer goggles, computer glasses, smartwatches, etc., may be substituted without departing from the scope of the technology disclosed herein. For example, when the document to be deposited is a personal check, the customer may select a customer account at the bank account (e.g., checking or savings) into which the funds specified by the check are to be deposited. Content associated with the document may include the funds or monetary amount to be deposited to the customer account, the issuing bank, the routing number, and the account number. Content associated with the customer account may include a risk profile associated with the account and the current balance of the account. Options associated with a remote deposit process may include continuing with the deposit process or cancelling the deposit process, thereby cancelling depositing the check amount into the account.

Mobile computing device 102 may communicate with a bank or third party using a communication or network interface (not shown). Communication interface may communicate and interact with any combination of external devices, external networks, external entities, etc. For example, communication interface may allow mobile computing device 102 to communicate with external or remote devices over a communications path, which may be wired and/or wireless (or a combination thereof), and which may include any combination of LANs, WANs, the Internet, etc. Control logic and/or data may be transmitted to and from mobile computing device via a communication path that includes the Internet.

In an example approach, a customer may login to their mobile banking app, select the account they want to deposit a financial instrument into, then select, for example, a “deposit check” option that will activate their mobile device's camera 104 (e.g., activate the camera). One skilled in the art would understand that variations of this approach or functionally equivalent alternative approaches may be substituted to initiate a mobile deposit.

Using the camera 104 function on the mobile computing device 102, the customer may capture live imagery from a field of view 108 that includes at least a portion of one side of a financial instrument 106. Typically, the camera's field of view 108 will include at least the perimeter of the financial instrument 106. However, any camera position that generates in-focus financial instrument imagery 112 of the various data fields located on a financial instrument may be considered. Resolution, distance, alignment, and lighting parameters may require movement of the mobile device until a proper view of a complete financial instrument, in-focus, has occurred. An application running on the mobile computing device 102 may offer suggestions or technical assistance to guide a proper framing of a financial instrument within the mobile banking app's graphically displayed field of view window 110, displayed on a User Interface (UI) instantiated by the mobile banking app. A person skilled in the art of remote deposit would be aware of common requirements and limitations and would understand that different approaches may be required based on the environment in which the financial instrument viewing occurs. For example, poor lighting or reflections may require specific alternative techniques. As such, any known or future viewing or capture techniques are considered to be within the scope of the technology described herein. Alternatively, the camera may be remote to the mobile computing device 102. In an alternative embodiment, the remote deposit may be implemented on a desktop computing device with an accompanying digital camera.

Sample customer instructions may include, but are not limited to, “Once you've completed filling out the check information and signed the back, it's time to view your check,” “For best results, place your check or money order on a flat, dark-background surface to improve clarity,” “Make sure all four corners of the check fit within the on-screen frame to avoid any processing holdups,” “Select the camera icon in your mobile app to open the camera,” “Hold the camera still,” “Once you've viewed a clear image of the front of the check or money order, repeat the process on the back of the check or money order,” “Do you accept the funds availability schedule?” “Swipe the Slide to Deposit button to submit the deposit,” “Your deposit request may have gone through, but it's still a good idea to hold on to your check for a few days,” “Keep the check or money order in a safe, secure place until you see the full amount deposited in your account,” and “After the deposit is confirmed, you can safely destroy the check.” These instructions are provided as sample instructions or comments but any instructions or comments that guide the customer through a remote deposit session may be included.

In a non-limiting example, live streamed image data captured using camera 104 may be assembled into one or more frames of image content. In some embodiments, a data signal from a camera sensor (e.g., CCD) may notify the banking app when an entire sensor has been read out as streamed data. In this approach, the camera sensor may be cleared of electrons before a subsequent exposure to light and a next image frame is captured. This clearing function may be conveyed to the mobile banking app, and/or a ML framework operating on mobile computing device 102, to indicate that the Byte Array Output Stream object constitutes a complete frame of image data. In some embodiments, the images formed into a byte array may be first rectified to correct for distortions based on an angle of incidence, may be rotated to align the imagery, may be filtered to remove obstructions or reflections, and may be resized to correct for size distortions using known image processing techniques. In some embodiments, these corrections may be based on recognition of corners or borders of the financial instrument as a basis for image orientation and size, as is known in the art.

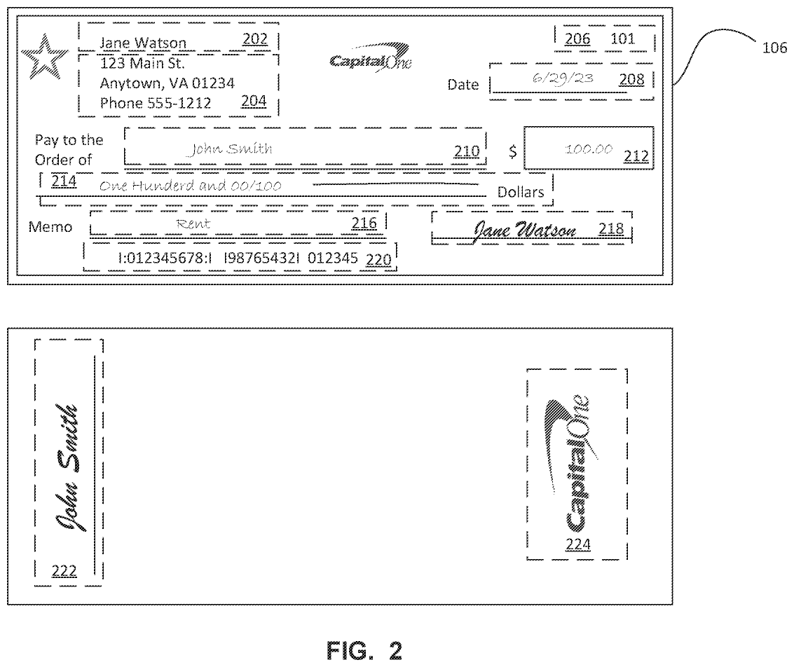

FIG. 2 illustrates example remote deposit OCR segmentation, according to some embodiments. Depending on financial instrument type, a financial instrument may have a fixed number of identifiable fields. For example, a financial instrument may have front side fields, such as, but not limited to, a payer customer name 202 and address 204, check number 206, date 208, payee field 210, payment amount 212, a written amount 214, memo line 216, Magnetic Ink Character Recognition (MICR) line 220 that includes a string of characters including the bank routing number, the payer customer's account number, and the check number, and finally the payer customer's signature 218. Back side identifiable fields may include, but are not limited to, payee signature 222 and security fields 224, such as a watermark.

While a number of fields have been described, it is not intended to limit the technology disclosed herein to these specific fields as a check or other financial instrument may have more or less identifiable fields than disclosed herein. In addition, security measures may include alternative approaches discoverable on the front side or back side of the financial instrument or discoverable by processing of identified information. For example, the remote deposit feature in the mobile banking app running on the mobile computing device 102 may determine whether the payment amount 212 and the written amount 214 are the same. Additional processing may be needed to determine a final amount to process the financial instrument if the two amounts are inconsistent. In one non-limiting example, the written amount 214 may supersede any amount identified within the amount field 212.

In some embodiments, successful validation of a financial instrument may depend on correctly extracting from an image of financial instrument 106, via OCR processing, the fields required to complete a remote deposit of financial instrument 106. As a non-limiting example, successful validation of financial instrument 106 may refer to correctly extracting at least MICR line 220, check number 206, payee field 210, and payment amount 212. Successfully validation of financial instrument 106 need not include correctly extracting all identifiable fields from the image (such as all fields identified in FIG. 2). Various financial instrument processing platforms may be used in a remote deposit system, and these processing platforms may be implemented by a bank using third party software. Accordingly, various OCR processing systems and validations may be implemented depending on the remote deposit system, and their inner workings may not be readily known to the bank. As used herein, successful validation may refer to cases in which an image submitted to a financial instrument image processing system, either implemented by a bank or a third party, is not returned due to the financial instrument being an impermissible type.

OCR is the electronic or mechanical conversion of images of typed, handwritten or printed text into machine-encoded text, whether from a scanned document, a photo of a document, a scene photo, stream of image data, etc. Utilizing OCR, data (e.g., financial instrument amount, signature, MICR line, account number, etc.) may be extracted from one or more images of a financial instrument and used to process a remote deposit.

In some embodiments, OCR processing of an image of a financial instrument may include OCR processing performed at a backend system, for example, during a financial instrument image validation process. In such embodiments, the OCR processing may be implemented by a bank associated with a mobile banking app or may be implemented using third-party software hosted on a cloud banking system. OCR processing may include, but is not limited to, verification of data extracted from fields of the financial instrument based on a comparison with historical customer account data found in the customer's account (e.g., customer account 408) or the payer's account. In one non-limiting example, an address may be checked against the current address found in a data file of a customer account. In another non-limiting example, OCR processing may include checking a signature file within a customer account to verify the payee or payer signatures. It is also contemplated that a third party database may be checked for funds and signatures for financial instruments from payers not associated with the customer's bank. Additional known OCR processing techniques may be substituted without departing from the scope of the technology described herein. Further, in some embodiments, OCR processing may be performed at mobile computing device 102. In some embodiments, the real-time image assessment described herein may be performed prior to any OCR processing, regardless of where it occurs, to avoid OCR processing costs if the image is associated with an impermissible financial instrument type.

FIG. 3 illustrates a remote deposit system architecture 300, according to some embodiments. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 3, as will be understood by a person of ordinary skill in the art.

As described throughout, a client device 302 (e.g., mobile computing device 102) may implement remote deposit processing for one or more financial instruments, such as checks or money orders. The client device 302 may be configured to communicate with a cloud banking system 316 to complete various phases of a remote deposit as will be discussed in greater detail hereafter.

In some embodiments, the cloud banking system 316 may be implemented as one or more servers. Cloud banking system 316 may be implemented as a variety of centralized or decentralized computing devices. For example, cloud banking system 316 may be a mobile device, a laptop computer, a desktop computer, grid-computing resources, a virtualized computing resource, cloud computing resources, peer-to-peer distributed computing devices, a server farm, or a combination thereof. Cloud banking system 316 may be centralized in a single device, distributed across multiple devices within a cloud network, distributed across different geographic locations, or embedded within a network. Cloud banking system 316 may communicate with other devices, such as a client device 302. Components of cloud banking system 316, such as Application Programming Interface (API) 318, file database (DB) 320, as well as backend 322, may be implemented within the same device (such as when a cloud banking system 316 is implemented as a single device) or as separate devices (e.g., when cloud banking system 316 is implemented as a distributed system with components connected via a network).

Mobile banking app 304 may be a computer program or software application designed to run on a mobile device such as a phone, tablet, or watch. However, in a desktop application, a desktop equivalent of the mobile banking app may be configured to run on desktop computers, and web applications, which run in mobile web browsers rather than directly on a mobile device, may be implemented for mobile banking app 304. Applications or apps may be broadly classified into three types: native apps, hybrid, and web apps. Native applications may be designed specifically for a mobile operating system, such as iOS or Android. Web apps may be designed to be accessed through a web browser. Hybrid apps may be built using web technologies such as JavaScript, CSS, and HTML5 and function like web apps disguised in a native container.

Mobile banking application (app) 304, resident on client device 302, may include a computer instruction set to provide a secure mobile device banking session. The banking app may allow a customer to interact with their bank account information. For example, common functions include, but are not limited to, checking an account balance, transferring money between accounts, paying bills, making deposits, to name a few.

In some embodiments, mobile banking app 304 may include executable software that may communicate with various systems within client device 302 to provide ML functionality. For example, ML frameworks, for example, those provided by Core ML (iOS) or ML Kit (Android or iOS), may be implemented to establish communications between mobile banking app 304 and client device 302's ML capabilities. Mobile banking app 304 may include software instructions that interact with application programing interfaces (APIs), programs, libraries, and/or modules of an ML framework. When executed, instructions on mobile banking app 304 may cause ML models implemented by the ML framework and operating on client device 302 to receive and assess image data. As an example, mobile banking app 304 may execute an API call to a Core ML or ML Kit framework to run an image classification ML model and obtain an image classification and/or a confidence score associated with the classification (e.g., using the Vision framework supported by ML Core or the MLKitVision framework provided by ML Kit). The image classification ML model may receive image pixel data gathered via a camera of client device 302, along with image metadata in some embodiments. The image classification ML model may determine, based on the image pixel data and/or image metadata, what type of financial instrument is depicted in an image and/or whether an acceptable type of financial instrument is depicted, and may provide its classification(s) to mobile banking app 304. In some embodiments, a classification may be provided along with a confidence score indicating a likelihood the classification is correct. In some embodiments, a classification of whether or not the type of financial instrument is accepted, with or without a confidence score, may be provided by the image classification ML model. While image classification ML models are discussed, any predictive ML model may be implementing using Core ML and ML Kit frameworks.

While Core ML and ML Kit are discussed above as example ML frameworks/software development kits (SDKs), it should be understood that any suitable ML framework or SDK may be implemented. Various functions of the ML framework(s) implemented may be integrated with mobile banking app 304 or may operate on client device 302 but be separate from mobile banking app 304.

Financial instrument imagery may originate from any of, but not limited to, image streams (e.g., series of pixels or frames) or video streams or a combination of any of these or future image formats. A customer using a client device 302, operating a mobile banking app 304 through an interactive UI 306, may frame at least a portion of a financial instrument (e.g., identifiable fields on the front or back of the financial instrument) with a camera (e.g., field of view). In some embodiments, imagery may processed from live stream financial instrument imagery, as communicated from camera 308 over a period of time, until an image assessment has been completed.

In some embodiments, image data may be assembled into one or more frames of image content. In some embodiments, a data signal from a camera sensor (e.g., a charge-coupled device (CCD) or an active-pixel sensor (such as a complementary metal-oxide-semiconductor (CMOS) image sensor)) may notify mobile banking app 304 and/or mobile ML platform 310 when an entire sensor has been read out as streamed data. In this approach, the camera sensor may be cleared of electrons before a subsequent exposure to light and a next frame of an image is captured. This clearing function may be conveyed to mobile banking app 304 and/or mobile ML platform 310 to indicate that a Byte Array Output Stream object constitutes a complete frame of image data. In some embodiments, images formed into a byte array may be first rectified to correct for distortions based on an angle of incidence, may be rotated to align the imagery, may be filtered to remove obstructions or reflections, and/or may be resized to correct for size distortions using known image processing techniques. In some embodiments, these corrections may be based on recognition of corners or borders of the financial instrument as a basis for image orientation and size, as is known in the art.

In some embodiments, the camera imagery may be streamed as encoded text, such as a byte array. Alternatively, or in addition, one or more frames of the live imagery may be stored (e.g., at least temporarily) as images in computer memory. For example, one or more frames of live streamed financial instrument imagery from camera 308 may be stored locally in image memory 312, which may be, but is not limited to, a frame buffer, a video buffer, a streaming buffer, a virtual buffer, a hard drive, etc.

In some embodiments, image data may be stored in any known file format, for example, as a JPEG, PNG, TIFF, HEIC, or RAW file, or any other file type that supports metadata storage, before being provided to mobile ML platform 310. In some embodiments, metadata may be stored in a variety of formats within an image file, including one or more of EXIF, XMP, XML, 8BIM, IPTC, or ICC formats.

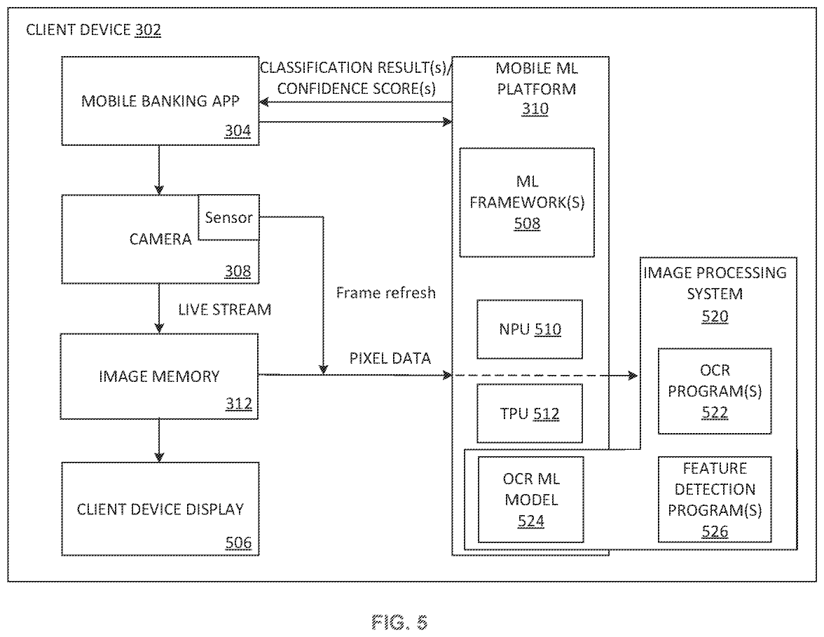

Mobile ML platform 310, which in some embodiments may be resident on the client device 302, may process one or more images (e.g., image frames extracted from a live image stream) received from camera 308 and/or image memory 312 to determine the type of a financial instrument depicted in the one or more images and/or whether the financial instrument is an acceptable type. In some embodiments, the image assessment process may be completed before finalization of a remote deposit operation. Accordingly, in such embodiments, a document acceptance status may be communicated to or determined by mobile banking app 304 for display on UI 306 before the one or more images are forwarded for further processing. In some embodiments, mobile ML platform 310 may include one or more ML frameworks which may implement predictive ML models (e.g., image classification ML models or regression ML models, etc.), as discussed in more detail with respect to FIG. 5.

Account identification 314 may use single or multiple level login data from mobile banking app 304 to initiate a remote deposit. Alternately, or in addition, in some embodiments, the extracted payee field 210 or the payee signature 222 may be used to provide additional authentication of the customer.

Mobile ML platform 310 (e.g., ML framework(s) operating on mobile ML platform 310) may communicate with a cloud banking system 316. For example, mobile ML platform 310 may communicate with cloud banking system 316 to receive trained ML models and/or provide data to cloud banking system 316 that may be used in continuous training of ML models deployed on client device 302 (e.g., a history of predictions, confidence scores, images, and/or image metadata). In some embodiments, such data may be communicated to file database (DB) 320 either through a mobile app server 332 or mobile web server 334 depending on the configuration of the client device (e.g., mobile or desktop). In some embodiments, such data may be communicated through the mobile banking app 304.

Alternatively, or in addition, in some embodiments, a thin client (not shown) resident on the client device 302 may implement ML models or ML model training as disclosed herein to provide local image assessment with assistance from cloud banking system 316. For example, a processor (e.g., CPU) may implement at least a portion of image assessment using resources stored on a remote server instead of a localized memory. The thin client may connect remotely to the server-based computing environment (e.g., cloud banking system 316) where applications, sensitive data, and memory may be stored.

Backend 322 may include one or more system servers processing banking deposit operations in a secure environment. These one or more system servers may operate to support client device 302. API 318 may be an intermediary software interface between mobile banking app 304, installed on client device 302, and one or more server systems, such as, but not limited to the backend 322, as well as third party servers (not shown). The API 318 may be available to be called by mobile clients through a server, such as a mobile edge server (not shown), within cloud banking system 316. File DB 320 may store files received from the client device 302 or generated as a result of processing a remote deposit.

Profile module 324 may retrieve customer profiles associated with the customer from a registry based on customer data extracted from front or back images of the financial instrument (e.g., via OCR processing). Customer profiles may be used to determine deposit limits, historical activity, security data, or other customer related data.

Validation module 326 may generate a set of validations including, but not limited to, any of: mobile deposit eligibility, account, image, transaction limits, duplicate financial instruments, amount mismatch, MICR, multiple deposit, etc. While shown as a single module, the various validations may be performed by, or in conjunction with, the client device 302, cloud banking system 316, or third party systems or data. In some embodiments, OCR processing and/or other image processing of an image of a financial instrument may be performed by validation module 326, which may return a result of image processing (pass/fail). In some embodiments, determination of impermissible/acceptable financial instrument type (and sometimes financial instrument type itself) may be performed in concert with other image processing (e.g., OCR) and/or by a person at validation module 326. In some embodiments, the determination(s) may be communicated to file DB 320 for storing with the image. In some embodiments, such as when training of an ML model is performed at client device 302, the determination(s) may be communicated to mobile banking app 304 via mobile app server 332. The determination(s) may be used to refine ML image assessment models as disclosed herein.

Customer Accounts 328 (consistent with customer's accounts 408) may include, but is not limited to, a customer's financial banking information, such as individual, joint, or commercial account information, balances, loans, credit cards, account historical data, etc.

ML platform 329 may include a predictive ML model and/or a ML engine to train a predictive ML model used to assess images to determine financial instrument type and/or financial instrument type acceptability. For example, while the above disclosure has focused on a predictive ML model operating on client device 302, in some embodiments, the predictive ML model may operate on ML platform 329. In such embodiments, mobile banking app 304 may communicate an image, via mobile app server 332 and/or API 318, to the predictive ML model running on ML platform 329. The predictive ML model running on ML platform 329 may return an image classification result and/or associated confidence score to mobile banking app 304 in real time (e.g., within a current customer transaction period before the payee customer submits a deposit request or immediately after in response to the payee customer submitting the deposit request).

In some embodiments, ML platform 329 may be used to train a predictive ML model that may then be made available to mobile banking app 304 via mobile ML platform 310. In such embodiments, ML platform 329 may include or implement ML platforms such as Create ML (Mac), TensorFlow (Windows), or any suitable platform for training ML models.

This disclosure is not intended to limit ML platform 329 to only image assessment as it may also include or be used to train and/or implement remote deposit models, risk models, funding models, security models, dynamic funds availability models, etc.

In some embodiments, ML platform 329 may include software produced and implemented by the bank providing mobile banking app 304, and not third-party software. Alternatively, or in addition, ML platform 329 may include software produced and implemented by a third party.

In some embodiments, a funds availability schedule may be generated using an ML platform 329, as described in U.S. application Ser. No. 18/509,748, filed Nov. 15, 2023 and titled “DEPOSIT AVAILABILITY SCHEDULE,” the disclosure of which is incorporated by reference herein in its entirety. When a funds availability schedule is generated, it may be passed back to the client device 302 through API 318 where it may be formatted for communication and display on the client device 302. For example, the funds availability schedule may be communicated for display or rendering on the customer's device through the mobile banking app UI 306. In some embodiments, UI 306 may instantiate the funds availability schedule as images, graphics, audio, additional content, etc.

Pending deposit 330 may include a profile of a potential upcoming deposit(s) based on an acceptance by the customer through UI 306 of a deposit according to given terms. If the deposit is successful, the system may create a record for the transaction and this function may retrieve a product type associated with the account, retrieve data on customer interactions with UI 306, and create a pending financial instrument deposit activity.

One or more components of the remote deposit process described above may be implemented within the client device 302, third party platforms, the cloud-based banking system 316, or distributed across multiple computer-based systems.

Additionally, while the embodiments of FIG. 3 are discussed in the context of remote deposit, components and/or features of remote deposit system 300 may be implemented in any electronic document verification system. For example, in some embodiments, backend 322 may include server(s) implementing identification document verification based on image(s) of identification documents provided via client device 302. In some embodiments, client device 302 may implement a mobile ML platform 310 that is used to determine identification document type data in real-time as disclosed herein for a financial instrument. Likewise, alternatively or additionally, ML platform 329 may be used to determine identification document type data as disclosed herein for a financial instrument. The disclosure related to one or more components and/or features of remote deposit system 300 may be applied in system architectures for any digital document verification process.

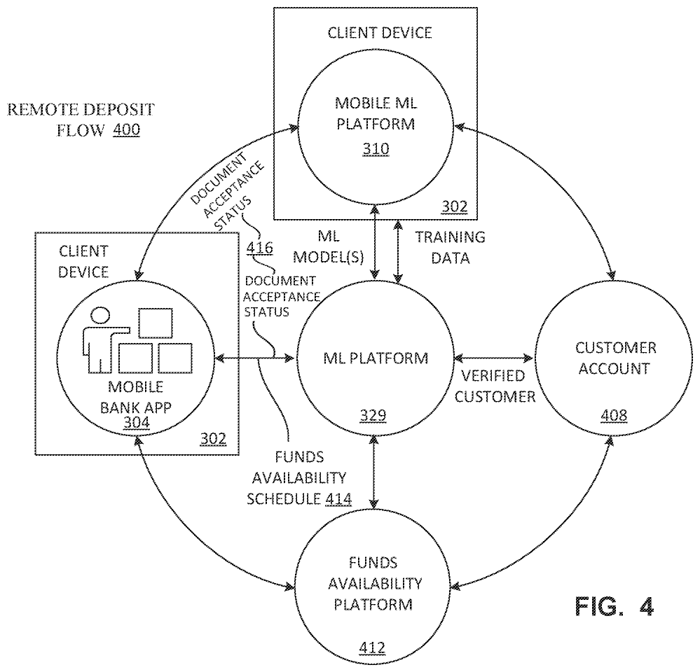

FIG. 4 illustrates an example flow diagram of a remote deposit system, according to some embodiments. The remote deposit flow 400 may include one or more system servers processing banking deposit operations in a secure closed loop. While described for a mobile computing device, desktop solutions may be substituted without departing from the scope of the technology described herein. These system servers may operate to support mobile computing devices from the cloud. It is noted that the structural and functional aspects of the system servers may wholly or partially exist in the same or different ones of the system servers or on the mobile device itself. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 4, as will be understood by a person of ordinary skill in the art.

In one non-limiting example, a bank customer using a client device 302 (e.g., mobile computing device 102), operating a mobile banking app 304, may frame at least a portion of a financial instrument within a field of view from an active camera (e.g., camera activated) of client device 302. As previously described, the imagery within the field of view may, in some embodiments, be configured as a live stream. In some embodiments, the camera imagery may be streamed as encoded text, such as a byte array (e.g., as a Byte Array Output Stream object). In some embodiments, this live stream of image data may be processed, without requiring image storage, using a client device resident mobile ML platform 310 (e.g., including ML framework(s)). In alternative embodiments, one or more frames of the camera imagery may be at least temporarily stored and subsequently processed by mobile ML platform 310. In some embodiments, a blended image as disclosed in U.S. application Ser. No. 18/503,787, filed Nov. 7, 2023 and titled “BURST IMAGE CAPTURE,” the disclosure of which is incorporated by reference herein in its entirety, may be captured and subsequently processed by mobile ML platform 310.

An ML model implemented by mobile ML platform 310 may provide an image assessment in real time, based upon which a document acceptance status 416 may be generated in real time (e.g., within a current customer transaction period before the payee customer submits a deposit request or immediately after in response to the payee customer submitting the deposit request). In some embodiments, document acceptance status 416 may include an image acceptance status indicating whether or not an image is accepted for a deposit attempt or access request. In some embodiments, for mobile deposit, in cases in which the image depicts an impermissible financial instrument type, the document acceptance status 416 may indicate such (and optionally identify the impermissible type); while, in cases in which the image depicts a permissible financial instrument type, the document acceptance status 416 may simply indicate that the image was accepted. Document acceptance status 416 may communicate similar information for an image of an identification document provided as part of an access request.

Sample document acceptance statuses 416 may include, but are not limited to, “You are attempting to deposit a money order. Money orders may be deposited in person or by mailing your money order to BANK ADDRESS,” “You are attempting to deposit a traveler's check. Traveler's checks may only be deposited in person,” “Your deposit request has been received,” etc. These statuses are provided as sample statuses or instructions but any statuses or instructions that provide guidance on financial instrument or document type may be included. UI 306 may instantiate a document acceptance status 416 as images, graphics, audio, additional content, etc.

In some embodiments, document acceptance status 416 may be generated based on results of an image classification ML model running at either mobile ML platform 310 or ML platform 329. In the second case, in some embodiments, the document acceptance status 416 may be generated at cloud banking system 316 (e.g., at API 318 or ML platform 329) and transmitted to mobile banking app 304 for display. In the first or second case, in some embodiments, document acceptance status 416 may be generated by mobile banking app 304 based on the results of the image classification ML model.

In one technical improvement over current processing systems, the document acceptance status 416 may be provided mid-stream, prior to a customer submitting a deposit request or immediately after in response to the customer submitting the deposit request. In this approach, the customer may terminate the process prior to completion if they are dissatisfied with the document acceptance status 416, or may retake an image.

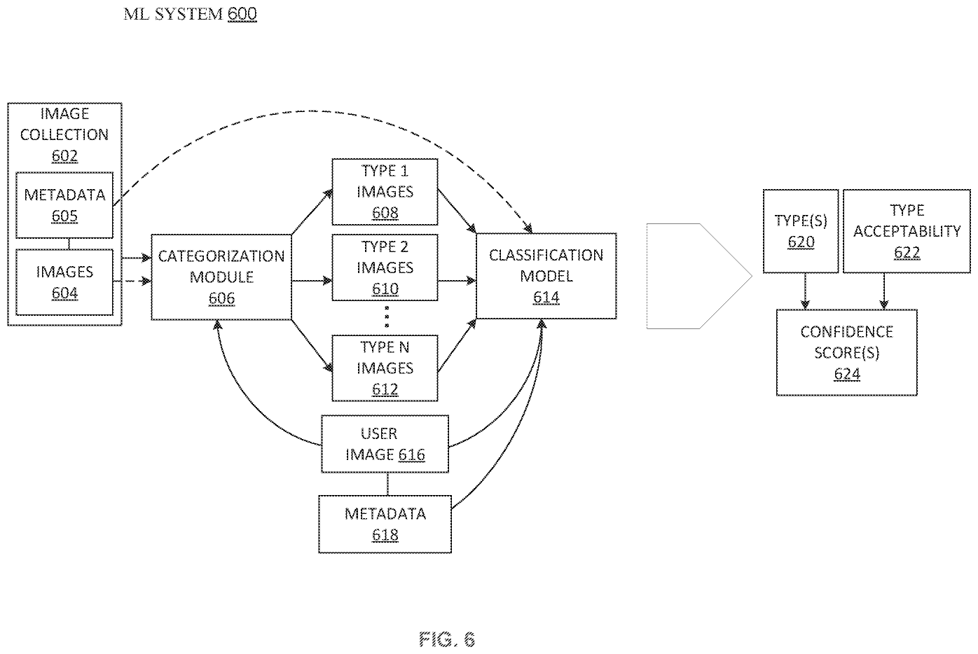

ML platform 329 and mobile ML platform 310 may be in communication for the training and refinement of ML models implemented by mobile ML platform 310. For example, ML algorithms may be trained on ML platform 329 using training data, which may include images captured by client device 302. A resulting ML model may be provided to client device 302. Additionally, the ML model may be continuously refined. In some embodiments, the ML model may be refined on ML platform 329 based on training data that may be provided to ML platform 329 by client device 302. The training data may include images and associated data. In some embodiments, the associated data transmitted by client device 302 may include results of real time ML image assessment performed at client device 302 and/or image metadata from the time of image capture (e.g., image metadata such as metadata 605/metadata 618 described with respect to FIG. 6). In such embodiments, items of the associated data may be associated with individual images. In some embodiments, an ML model refined at ML platform 329 may be provided to client device 302 and may be accessible in new versions of mobile banking app 304 (i.e., the refined model may be provided as part of a software update).

In some embodiments, an ML model may be refined on client device 302. For example, in the case of a predictive ML model operating on client device 302, refining the model may include determining a later classification of a document depicted in an image conflicts with the financial instrument type/type acceptability predicted based on the results of the predictive ML model's analysis. This determination may be performed on cloud banking system 316, for example, by validation module 326. In such cases, the predictive ML model may have provided a prediction that the image depicted an acceptable financial instrument type, and/or a confidence score that met a threshold for such a prediction, and based on the predictive ML model's prediction, the image may have been forwarded for further processing. But the image may have been rejected due to the financial instrument depicted not being an accepted type. Additionally or alternatively, the image may have been classified (e.g., by a person or program operating as part of validation 326) as a different type than a predicted type, even though validation succeeded. In such cases, refining the predictive ML model may include providing the determination that the prediction of the predictive ML model was incorrect (and optionally providing the correct classification). The determination may be provided with the image in question or with an identifier for locating the image within image memory 312. Accordingly, mobile banking app 304 may receive or create a label associated with the image, based on the determination. Mobile banking app 304 may then provide the labeled image (with or without image metadata) to the predictive ML model for further training on an ML framework of mobile ML platform 310. In some embodiments, cloud banking system 316 and mobile banking app 304 may do the same for an image for which the prediction was correct to further facilitate continuous training of the predictive ML model.

In embodiments in which the predictive ML model may be trained and/or refined at client device 302, the predictive ML model may be a file (e.g., an .mlmodel file for Core ML) that is configured to allow updating (e.g., the model may be marked as updatable and/or has training inputs). In the case of a neural network, the file may be made updateable by marking certain layers as updatable, including one or more loss functions (e.g., cross-entropy or mean squared error (MSE)), including an optimizer (stochastic gradient descent (SGD) or Adam), and/or including default values for the hyperparameters (e.g., the number of epochs).

While the above process has been described for refining the predictive ML model on client device 302, in some embodiments, the same or a similar process may be performed on ML platform 329. In some embodiments, the predictive ML model may be trained and/or refined using distributed training, leveraging the interactions of multiple client devices 302 and cloud banking system 316, where each client device 302 constitutes a node in the distributed training network. In such embodiments, the distributed training may implement a data parallelism approach.

Client device 302 may obtain and transmit financial instrument images, including front and back images of a financial instrument, captured using camera 308. The financial instrument images may then be stored in the customer account 408 for later use if necessary. In some embodiments, the financial instrument images may be stored (e.g., in file DB 320) with associated data including image metadata, results of real time ML image assessment, final financial instrument type/type acceptability determinations, or any combination thereof. The financial instrument images and associated data may be used to refine one or more ML models operating within remote deposit flow 400, as described above.

The customer account 408, for purposes of description, may be the payee's account, the payer's account or both. For example, a payee's account historical information may be used to calculate a payee's funds availability schedule 414, while a payer's account may be checked for funds to cover the financial instrument amount.

Data fields extracted in an OCR operation may be communicated to a funds availability platform 412. For example, customer data (e.g., name, address, account number, bank information (e.g., routing information), financial instrument number (e.g., check number), financial instrument amount (e.g., funding amount needed), authorization and anti-fraud information (e.g., signature verifications, watermark or other financial instrument security imagery), etc. may be communicated to funds availability platform 412.

ML platform 329, in communication with funds availability platform 412, may compute a funds availability schedule 414 based on one or more of the received data fields, customer history received from the customer's account 408, bank funding policies, legal requirements (e.g., state or federally mandated limits and reporting requirements, etc.), or typical schedules stored within funds availability platform 412, to name a few. ML platform 329 may return a fixed or dynamically modifiable funds availability schedule 414 to the UI 306 on the client device 302. ML platform 329 may perform any of the above functions in line with the disclosure of U.S. application Ser. No. 18/509,748, filed Nov. 15, 2023 and titled “DEPOSIT AVAILABILITY SCHEDULE,” which is incorporated by reference herein in its entirety.

In a non-limiting example, OCR of a financial instrument image may identify the MICR data as a verified data field that may be used to access a customer's account 408. This access may allow the bank identified in the MICR to provide a history of the customer's account 408 to the ML platform 329, via any channel of remote deposit system architecture 300. Early access to the customer's account may also provide a verified customer for security purposes to eliminate or reduce fraud in the remote deposit process.

ML platform 329 may provide funds availability schedule 414, which may be communicated and rendered on the client device 302 within one or more user interfaces (UIs) of the customer device's mobile banking app 304. The rendering may include imagery, text, or a link to additional content. The UI may instantiate the remote funds availability schedule 414 as images, graphics, audio, etc. In some embodiments, an estimated date of deposit may be communicated. In some embodiments, funds availability schedule 414 and document acceptance status 416 may be combined and communicated simultaneously. In some instances, funds availability schedule 414 may include a notice of failed processing (e.g., OCR processing of a deposit financial instrument image has failed).

Alternatively, or in addition, one or more components of the remote deposit flow 400 may be implemented within the customer device, third party platforms, and a cloud-based system or distributed across multiple computer-based systems.

FIG. 5 illustrates an example diagram of a client device 302, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 5, as will be understood by a person of ordinary skill in the art.

In some embodiments, the mobile banking app 304 may be opened on the client device 302 and the deposit check function selected to initiate a remote deposit process. A camera may be activated (e.g., camera 308) to communicate a live stream of imagery (e.g., frames of video) from a field of view of the camera 308. A camera may output, for display at client display device 506, a frame (e.g., an image frame or a frame of a video, for example) depicting one or more real-world objects that are viewable by camera 308. For instance, an image may depict an entire group of financial instruments in a field of view of camera 308, or the image may depict one or more individual objects within the group. In some embodiments, the image of decodable financial instrument indicia may be provided by a raw image byte stream or by a byte array, a compressed image byte stream or byte array, and/or a partial compressed image byte stream or byte array.

At this point, the customer of the client device 302 may view the live stream of imagery on a UI of the client device display 506, after buffering in image memory 312, which may include a buffer (e.g., frame buffer, video buffer, etc.). In some embodiments, the live stream may communicated to mobile ML platform 310 as a raw image live stream. In some embodiments, the raw image live stream may first be converted to a byte array and then communicated to mobile ML platform 310 (buffered or not buffered, or after being stored in permanent memory). The data embedded in the byte stream or byte array may then extracted by a predictive ML model implemented by ML framework(s) 508 of mobile ML platform 310, processed, and used to issue a prediction (e.g., a classification result and/or confidence score). This prediction may be transmitted to mobile banking app 304 periodically (e.g., after an image has been provided to the predictive ML model) or continuously (e.g., as frames in a continuous image stream are being assessed). In embodiments in which a live stream is provided to the predictive ML model, the prediction output by the predictive ML model may be used to trigger automatic image capture (e.g., selecting and storing and/or transmitting an image frame for further processing). For example, in some embodiments, mobile banking app 304 may be configured to not store or process an image that is associated with an impermissible financial instrument type (as determined using the predictive ML model). Instead, a message may be provided to a customer via document acceptance status 416. In some embodiments, mobile banking app 304 may be configured to automatically trigger image capture based on an image being associated with a permissible financial instrument type (as determined using the predictive ML model), optionally along with other factors.

In some embodiments, the front side imagery may be processed followed by the back side imagery. Alternatively, the front side and back side imagery may be processed together or in parallel.

As shown in FIG. 5, mobile ML platform 310 may include ML framework(s) 508, neural processing unit (NPU) 510, and/or tensor processing unit (TPU) 512. In some embodiments, mobile ML platform 310 may include both neural processing unit 510 and tensor processing unit 512. In some embodiments, mobile ML platform 310 may include either neural processing unit 510 or tensor processing unit 512.

Traditionally, machine learning models may be implemented on a mobile device using the processing capabilities of the mobile device's CPU and/or GPU. However, a NPU 510 or TPU 512 may be optimized for matrix operations, such as matrix multiplication and convolutions, which constitute some of the most common and computationally intensive mathematical operations performed in machine learning. Accordingly, NPUs and TPUs may be optimized for machine learning tasks, and in particular implementing artificial neural networks and deep learning.

ML framework(s) 508 may include programing interfaces (APIs), programs, libraries, and/or modules that operate on client device 302's CPU, GPU, NPU 510, and/or TPU 512. In some embodiments, ML framework(s) 508 may implement ML models that have been trained on ML platform 329 and downloaded onto client device 302 as part of mobile banking app 304's installation package. In some embodiments, ML framework(s) 508 may implement ML models that have been trained using ML framework(s) 508 on client device 302. In some embodiments, ML framework(s) 508 may be configured to implement computer vision ML models, such as computer vision-based predictive ML models (e.g., image classification ML models, computer vision-based regression models, etc.). As a non-limiting example, an ML framework 508 may be Apple's Vision framework, supported by Core ML.

In some embodiments, an image classification ML model operating on ML framework(s) 508 may be configured, via training at cloud banking system 316 and/or client device 302, to categorize an image provided to an image classification model as a certain financial instrument type. In some embodiments, the image classification ML model may further be configured to provide a confidence score associated with the categorization. For example, in some embodiments, the image classification ML model may be configured to provide both a confidence score (e.g., a percentage) predicting the most likely financial instrument type and a confidence score (e.g., a percentage) predicting the second most likely financial instrument type. For example, in such embodiments, the image classification ML may indicate that an image is 72.5% likely to depict a certified check, and 24.3% likely to depict a cashier's check. In some embodiments, the image classification ML model may be configured to provide only a confidence score predicting the most likely financial instrument type. In some embodiments, the image classification ML model may be configured to provide confidence scores for more than just the two most likely financial instrument types. In some embodiments, the image classification ML model may be configured to not provide a confidence score, but only a determination on financial instrument type (e.g., certified check).

Alternatively, or in addition, in some embodiments, an image classification ML model operating on ML framework(s) 508 may be configured, via training at cloud banking system 316 and/or client device 302, to categorize an image provided to an image classification model as either acceptable financial instrument type or impermissible financial instrument type. In some embodiments, the image classification ML model may further be configured to provide a confidence score associated with one or more of the type acceptability determinations. For example, in some embodiments, the image classification ML model may be configured to provide both a confidence score (e.g., a percentage) predicting whether the image depicts an acceptable financial instrument type and a confidence score (e.g., a percentage) predicting whether the image depicts an impermissible financial instrument type. For example, in such embodiments, the image classification ML may indicate that an image is 72.5% likely to depict an acceptable financial instrument type, and 27.5% likely to depict an impermissible financial instrument type. In some embodiments, the image classification ML model may be configured to provide only a confidence score predicting whether the image depicts an acceptable financial instrument type. In some embodiments, the image classification ML model may be configured to provide only a confidence score predicting whether the image depicts an impermissible financial instrument type. In some embodiments, the image classification ML model may be configured to not provide a confidence score, but only a binary determination (e.g., acceptable/impermissible).

Whether the image classification ML model is configured to provide, in response to receiving an image, a financial instrument type determination or a financial instrument type acceptability determination, or both, depends on how the image classification ML model is trained, as described with respect to FIG. 6.

In some embodiments, after providing a financial instrument image to a predictive ML model (e.g., an image classification ML model), mobile banking app 304 (or another component within remote deposit system 300) may receive a determination from the predictive ML model regarding a financial instrument type and/or a financial instrument type acceptability. For example, mobile banking app 304 (or the other component) may receive from the predictive ML model 1) a confidence score indicating a likelihood the financial instrument image depicts a certain financial instrument type (a financial instrument type confidence score, usually that for the most likely financial instrument type), and/or 2) a confidence score indicating a likelihood the financial instrument image depicts an acceptable financial instrument type (a financial instrument type acceptability confidence score, which may also be a confidence score indicating a likelihood the financial instrument image depicts an impermissible financial instrument type), as discussed above. In some embodiments, one or more predetermined thresholds may be set within mobile banking app 304.

In the first case, in response to the financial instrument type confidence score meeting a predetermined threshold related to financial instrument type certainty, mobile banking app 304 may then determine whether the determined financial instrument type is an acceptable (e.g., by comparison to a list), and if so, may forward the financial instrument image for further processing and validation (e.g., at cloud banking system 316 or a third party server). In response to the financial instrument type confidence score not meeting the predetermined threshold related to financial instrument type certainty, mobile banking app 304 may reject the financial instrument image and/or generate a document acceptance status 416 that indicates the financial instrument image is not accepted. In some embodiments, in response to the financial instrument type confidence score not meeting (e.g., being below) the predetermined threshold related to financial instrument type certainty, mobile banking app 304 may request re-capture of the image and/or may trigger auto-recapture to verify that other factors (e.g., blurriness) are not preventing a classification from being made. In some embodiments, once it is confirmed that no financial instrument type confidence score associated with a financial instrument being captured meets the predetermined threshold related to financial instrument type certainty, mobile banking app 304 may generate a document acceptance status 416 that further indicates the financial instrument being captured corresponds to no known financial instrument type.

In the second case, in response to the financial instrument type acceptability confidence score meeting a predetermined threshold related to financial instrument type acceptability certainty, mobile banking app 304 may forward the financial instrument image for further processing and validation (e.g., at cloud banking system 316 or a third party server). In the case of the financial instrument type acceptability confidence score being a confidence score predicting whether the image depicts an acceptable financial instrument type, meeting the predetermined threshold may include equaling or exceeding the predetermined threshold related to financial instrument type acceptability certainty. In the case of the financial instrument type acceptability confidence score being a confidence score predicting whether the image depicts an impermissible financial instrument type, meeting the predetermined threshold may include equaling or being less than the predetermined threshold related to financial instrument type acceptability certainty. In both cases, the financial instrument type acceptability confidence score may be associated with whether a financial instrument type is acceptable. In some embodiments, in response to the financial instrument type acceptability confidence score not meeting a predetermined threshold related to financial instrument type acceptability certainty, mobile banking app 304 may reject the financial instrument image and/or generate a document acceptance status 416 that indicates the financial instrument image is not accepted (and optionally that the financial instrument type is impermissible).

In some embodiments, the one or more predetermined thresholds may be set within the predictive ML model, rather than within mobile banking app 304. In such embodiments, the predictive ML model may provide one or more classification results (e.g., financial instrument type (including undetermined) and/or financial instrument type acceptability/impermissibility) based on one or more confidence scores meeting or not meeting one or more predetermined thresholds within the predictive ML model. In such embodiments, mobile banking app 304 may perform the above-described functions in response to the one or more classification results.

While mobile banking app 304 is described above as receiving confidence scores and performing actions, other components within remote deposit system architecture (e.g., programs or APIs operating on cloud banking system 316) may perform the operations described above, particularly if the predictive ML model is implemented off of client device 302.

Whether the one or more predetermined thresholds are set within mobile banking app 304 (or another component of remote deposit system 300) or the predictive ML model (or one in each), the one or more predetermined thresholds may be set manually (i.e., by direct coding) in response to one or more factors or automatically in response to the one or more factors. The factors may include a number of images used so far to train the predictive ML model (more images may lead to more accurate predictions) and/or a successful prediction rate (i.e., based on a percentage of images that have been incorrectly classified). In embodiments in which the predetermined threshold is set automatically, mobile banking app 304 or the trained predictive ML model may include a program that receives one or more of the above factors and returns the predetermined threshold.

In some embodiments, when the financial instrument type confidence score is used, the predetermined threshold related to financial instrument type certainty may be from 50% to 100%, including subranges. For example, in some embodiments, the predetermined threshold related to financial instrument type certainty may be from 55% to 100%, from 60% to 100%, from 65% to 100%, from 70% to 100%, from 75% to 100%, from 80% to 100%, from 85% to 100%, from 90% to 100%, or from 95% to 100%.

In some embodiments, when a financial instrument type acceptability confidence score that indicates a likelihood the financial instrument image depicts an acceptable financial instrument type is used, the predetermined threshold related to financial instrument type acceptability certainty may be from 50% to 100%, including subranges. For example, in some embodiments, the predetermined threshold may be from 55% to 100%, from 60% to 100%, from 65% to 100%, from 70% to 100%, from 75% to 100%, from 80% to 100%, from 85% to 100%, from 90% to 100%, or from 95% to 100%. In some embodiments, when a financial instrument type acceptability confidence score that indicates a likelihood the financial instrument image depicts an impermissible financial instrument type is used, the predetermined threshold related to financial instrument type acceptability certainty may be from 0% to 50%, including subranges. For example, in some embodiments, the predetermined threshold may be from 0% to 45%, from 0% to 40%, from 0% to 35%, from 0% to 30%, from 0% to 25%, from 0% to 20%, from 0% to 15%, from 0% to 10%, or from 0% to 5%.

While confidence scores that are percentages are discussed herein, other types of confidence scores are contemplated, such that a confidence score is not limited to a percentage. Confidence scores may be numbers on a scale, e.g., 0 to 1, 0 to 10, etc.

The technical solution disclosed above allows a real time financial instrument type assessment, without first requiring the upload and/or OCR processing of an image, and communication thereof. This solution accelerates the remote financial instrument deposit process.

In some embodiments, client device 302 may include an image processing system 520, as shown in FIG. 5. Image processing system 520 may be the same or substantially similar to image processing system 310 disclosed in U.S. application Ser. No. 18/607,884 (the '884 application), filed Mar. 18, 2024 and titled “DOCUMENT REMEMBRANCE AND COUNTERFEIT DETECTION,” the disclosure of which is incorporated by reference herein in its entirety. Image processing system 520 may include OCR program(s) 522 (corresponding to OCR program 508 of the '884 application), OCR ML model 524 (corresponding to OCR ML model 510 of the '884 application), and/or feature detection program(s) 526 (corresponding to feature detection program(s) 512 of the '884 application). Components of image processing system 520 may be implemented on client device 302, on cloud banking system 316, at a third-party server, or a combination thereof. OCR may be performed as instant OCR as described in U.S. application Ser. No. 18/092,617, filed Jan. 3, 2023 and titled “INSTANT OPTICAL CHARACTER RECOGNITION DURING UPLOAD PROCESS,” the disclosure of which is incorporated by reference herein in its entirety; as active OCR as described in U.S. application Ser. No. 18/503,778, filed Nov. 7, 2023 and entitled “ACTIVE OCR,” the disclosure of which is incorporated by reference herein in its entirety; or as any other OCR processing method, including traditional OCR performed at client device 302, cloud banking system 316, or a third-party server.

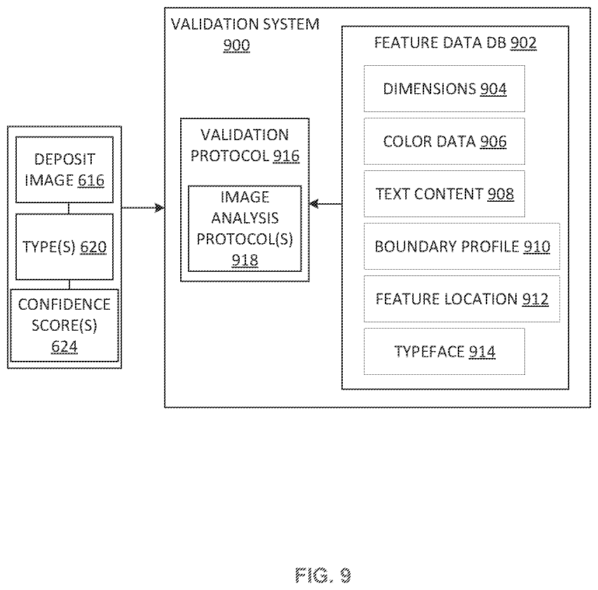

Feature data such as dimensions, color data, text content, boundary profile, feature location, and/or typeface of a financial instrument may be determined using feature detection program(s) 526, as described in detail in the '884 application (see description of FIG. 5 of the '884 application). Such feature data may be gathered by feature detection program(s) 526 to be used by a validation system (e.g., validation system 900 described with respect to FIG. 9) to customize a validation protocol.

FIG. 6 illustrates a machine learning (ML) system 600, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 6, as will be understood by a person of ordinary skill in the art.

ML system 600 illustrates the process of training and implementing a classification model 614. In some embodiments, classification model 614 may be a trained predictive ML model such as those described above. In some embodiments, ML system 600 may operate partially or entirely within remote deposit system architecture 300. Alternatively or additionally, in some embodiments, ML system 600 may operate partially or entirely at third party servers. In some embodiments, categorization module 606 may be accessible though API calls within remote deposit system architecture 300. In such embodiments, categorization module 606 may include third party software implemented within cloud banking system 316 or at a third party server.

As shown in FIG. 6, ML system 600 may include an image collection 602. In some embodiments, image collection 602 may include images captured using a client device 302 and submitted by one or more customers of mobile banking app 304 (or one or more customers of a software interface that enables image capture and submission from a mobile device). In some embodiments, image collection 602 may include images 604 gathered from third party sources (e.g., internet archives), with or without images 604 submitted by one or more customers of mobile banking app 304. Image collection 602 may include images depicting a financial instrument (e.g., financial instrument 106) or other document, such as images 604. In some embodiments, an image 604 may depict a front side of a financial instrument or other document. In some embodiments, an image 604 may depict both a front and a back side of a financial instrument or other document (e.g., be a merged picture). In some embodiments, an image 604 may depict a back side of a financial instrument or other document. In some embodiments, images 604 may include pixel data. In some embodiments, the pixel data may be RGB data, CMYK data, YCbCr data, HSV data, HSL data, hex codes, or any other pixel data that may be processed and analyzed by an ML model.

In some embodiments, image collection 602 may also include metadata 605. One or more items of metadata 605 may be associated with each of images 604. In some embodiments, metadata 605 may be linked to an image 604. For example, in some embodiments, items of metadata 605 may be stored with pixel data of the image 604 in a single image file, for example, a JPEG, PNG, TIFF, HEIC, or RAW file, or any other file type that supports metadata storage. In some embodiments, metadata 605 may be stored in a variety of formats within the image file, including one or more of EXIF, XMP, XML, 8BIM, IPTC, or ICC formats.

In some embodiments, metadata 605 may include a timestamp (e.g., date/time, and optionally sub-second time) that may be used to identify images 604. Additionally or alternatively, in some embodiments, metadata 605 may include values for parameters that may be associated with color and/or image capture conditions. For example, in some embodiments, metadata 605 may include values for shutter speed, focal length, aperture, f-number, ISO number, contrast, distance from the camera to the financial instrument in image 604 (e.g., determined using LiDAR at the time of image capture), or any combination thereof. These values may provide context for an image that will help classification model 614 normalize pixel data while being trained. For example, the combination of shutter speed, f-number, and ISO number, which affect exposure, may affect brightness (i.e., color intensity). Accordingly, when these values are included in training data with pixel data, the resulting model may learn to treat high brightness coupled with high exposure the same or similarly to how it treats low brightness coupled with low exposure. This may improve the accuracy of the model (i.e., the model will focus more on “real” similarities or differences between financial instruments depicted in images, and not those caused by camera settings or position of the camera with respect to a captured financial instrument).

Any one or combination of the above values may be associated with a particular image 604. As a non-limiting example combination, metadata 605 may include values for shutter speed, f-number, and ISO number, along with values for none or a subset of the other parameters indicated above (e.g., contrast). This combination may be useful since shutter speed, f-number, and ISO number may give information on exposure, which influences brightness.

In some embodiments, any one or combination of the above values may be added to image metadata (e.g., EXIF metadata) by mobile banking app 304 prior to mobile banking app 304 transferring an image 604 to complete a deposit. In some cases, when mobile banking app 304 adds a metadata value to image metadata, it may query software implementing client device 302's camera 308 to ascertain the metadata value. Alternatively, or in addition, any one or combination of the above values may be automatically added to image metadata (e.g., EXIF metadata) at the time of capturing an image by existing programs within client device 302.

In some embodiments, the distance from the camera to the financial instrument in an image may be determined by leveraging augmented reality (AR) capabilities of client device 302. For example, mobile banking app 304 may interact with an AR platform on client device, within which an AR framework such as ARKit (IOS) or ARCore (Android) may operate. The AR platform may include software and internal sensors (e.g., gyroscopes, accelerometers, magnetometers, and/or LiDAR sensors, ToF sensors, etc.) that can determine a real world position and orientation of various objects within the field of view of camera 502 both relative to a real world coordinate system and relative to camera 502, as described in more detail in U.S. patent application Ser. No. 18/529,623, filed Dec. 5, 2023 and titled “AUGMENTED REALITY DATA CAPTURE AID,” the disclosure of which is incorporated by reference in its entirety. Using the AR platform, mobile banking app 304 can obtain data on the real world distance between a plane (e.g., financial instrument 106) detected in the field of view of camera 502, for example, by leveraging plane detection and calculating distance to the center or a surface of the plane using the plane's coordinates. In some embodiments, the distance may be determined from an output of a LiDAR sensor or ToF sensor.

In some embodiments, alternatively or additionally, distance from the camera to a document in an image 604 or user image 616 may be determined using multiple lenses and/or cameras on client device 302, data from each of which may be compared to obtain depth data. For example, the difference in location of an object within two images captured using two lenses on the same device may be used to calculate distance to the object from the lenses.

While various types of metadata 605 have been described above, the examples provided are not limiting and it should be understood that any type of metadata 605 may be associated with an image 604 for training classification model 614. Training classification model 614 using both pixel data and metadata 605 may increase the accuracy and efficiency of the resulting classification model 614 by providing context for raw pixel data received by the model, enabling comparisons of received images to training data to be influenced more by real-world captured object features and less by camera settings.

As shown in FIG. 6, ML system 600 may also include categorization module 606. Categorization module 606 may be used to associate categorization data (e.g., labels) with images 604 for use in training classification model 614. In some embodiments, categorization module 606 may operate using resources of cloud banking system 316 and/or a third party server.

In some embodiments, categorization module 606 may include an image annotation platform. Using the image annotation platform, a programmer may manually label images 604 for use in supervised or semi-supervised learning. For example, in some embodiments, a programmer may input one or more labels for an image indicating a financial instrument type and/or whether the financial instrument type is acceptable/impermissible. Categorization module 606 may be configured to associate the one or more input labels with the image (e.g., by linking an image file name with one or more labels in a file, or by any other known method interpretable by an image classification machine learning algorithm).

In some embodiments, labeling of images 604 may be assisted by mobile banking app 304. For example, during the remote deposit process, mobile banking app 304 may request that a customer specify the type of financial instrument being deposited. Mobile banking app 304 may provide this information to categorization module 606 with an associated image(s) or identifier(s) identifying the associated image(s). In some embodiments, categorization module 606 may automatically label the image(s) based on the information provided by the customer. In some embodiments, categorization module 606 may display the information provided by the customer to a programmer, but the programmer may validate the information and assign a label based on the information. Accordingly, categorization module 606 may associate categorization data (e.g., labels) with each of images 604 automatically, in response to the direct inputs of a programmer, or both.

In some embodiments, categorization module 606 may operate at least partially as part of the standard remote deposit process. For example, in some standard remote deposit processes, determination of a financial instrument type or acceptable/impermissible type may already be accomplished as part of a validation process (e.g., part of validation 326) applied to a standard deposit request. In such cases, the determination(s) of the validation process may be provided to programs that run in categorization module 606, and categorization module 606 may pair the determinations with the associated images to label images 604. As part of that process, whether financial instrument type is received from customer inputs in mobile banking app 304 or via a validation process, categorization module 606 may include logic that receives the financial instrument type and determines whether it is an acceptable or impermissible financial instrument type.

In some embodiments, labeling images 604 may include assigning a financial instrument type label to an image 604. Alternatively, or in addition, labeling images 604 may include assigning a financial instrument type acceptability (e.g., acceptable/impermissible type) label to an image 604.

Associated categorization data (e.g., any one or more of the labels described above) may be provided with categorized images 604 to an untrained or partially trained classification model 614 to further train classification model 614. An “untrained or partially trained” model may refer to a model that is either an untrained ML algorithm or an ML algorithm that has received some training. Any level of training may be considered “partially trained” if a model can be further trained to fine-tune the model, for example, to better perform a specific task. An example of a partially trained ML model may be a pre-trained ML model. In some embodiments, a pre-trained classification model 614 may be trained on ML platform 329 using multiple customer's data, and then further trained on either ML platform 329 or mobile ML platform 310 using a single customer's data. In some embodiments, a pre-trained classification model 614 generated by a third party may be obtained and trained using transfer learning to repurpose the pre-trained classification model 614 to recognize the classes identified herein. The transfer learning may be conducted at ML platform 329 and may involve training as disclosed herein.

“Further train,” “further trained,” or “further training” should not be interpreted to mean that a model has already been at least partially trained before being “further trained.” Rather “further train,” “further trained,” or “further training” may refer to an ML model that was partially trained and has now undergone additional training, or may refer to an ML model that was entirely untrained and has undergone some training. Accordingly, “further trained” indicates that a model receives additional training, refinement, updating, etc., than it previously had. Likewise, “train,” “training,” or “trained” should not be interpreted to mean in all cases that a model is fully trained (e.g., using a particular method or at a particular location in remote deposit system 300) and cannot be refined or updated further, but only that some amount of training is being or has been performed (e.g., using a particular method or at a particular location).

In some embodiments, the categorized images 604 may include type 1 images 608 (e.g., personal checks), type 2 images 610 (e.g., cashier's checks), and type N images 612 (e.g., money orders), where N represents the number of types of financial instruments the further trained classification model 614 is configured to identify. While FIG. 6 shows images 604 categorized into financial instrument types, images may alternatively or additionally be categorized into financial instrument type acceptability categories (e.g., acceptable/impermissible). In some embodiments, images 604 may be categorized into two financial instrument type acceptability groups (acceptable type/impermissible type). In some embodiments, images 604 may categorized into financial instrument types, as shown, and also categorized into the two financial instrument type acceptability groups (e.g., the labels for a single image may include a financial instrument type label and a separate binary label indicating whether the financial instrument type is an acceptable type).

In some embodiments, along with categorized images 604, metadata 605 may be provided to the untrained or partially trained classification model 614 to further train classification model 614. In some embodiments, metadata 605 may be passed with images 604 through categorization module 606, such that each of type 1 images 608, type 2 images 610, . . . type N images 612 is linked with items of metadata 605 as categorization is conducted. In alternative embodiments, metadata 605 may be provided directly to classification model 614 and linked with individual type 1 images 608, type 2 images 610, . . . type N images 612 after categorization is conducted. In some embodiments, items of metadata 605 and individual type 1 images 608, type 2 images 610, . . . type N images 612 may be linked based on an identifier (e.g., a numeric or alphanumeric identifier) that is shared by the items of metadata 605 and the individual type 1 image 608, type 2 image 610, . . . type N images 612. In some embodiments, the identifier may include a timestamp. In some embodiments, each of images 604 may be associated with an identifier, and each identifier may remain associated with each image 604 throughout the process of the images 604 being categorized as type 1 images 608, type 2 images 610, . . . type N images 612.

In some embodiments, type 1 images 608, type 2 images 610, . . . type N images 612, categorization data, and/or associated metadata 605 may be provided to an untrained or partially trained classification model 614 simultaneously to further train classification model 614. In alternative embodiments, type 1 images 608, type 2 images 610, . . . type N images 612, categorization data, and/or associated metadata 605 may be provided to untrained or partially trained classification model 614 one image at a time to further train classification model 614, for example, at a frequency determined by remote deposit activity of one or more customers of mobile banking app 304. In such embodiments, image collection 602 need not represent a collection of images gathered and jointly processed to create training data, but may represent images processed and submitted to untrained or partially trained classification model 614 as they are received from customers of mobile banking app 304. In such embodiments, classification model 614 may exist in a passive state (e.g., while it is being further trained) for a predetermined time before being activated on client device 302 and/or downloaded to client device 302. In some embodiments, the predetermined time may be based on a threshold number of images used to further train classification model 614 (e.g., classification model 614 is in the passive state until the threshold number is reached, when it is automatically activated and/or downloaded). In some embodiments, classification model 614 may be further trained at ML platform 329. Alternatively, or in addition, classification model 614 may be further trained at mobile ML platform 310.

In some embodiments, type 1 images 608, type 2 images 610, etc. may be provided to untrained or partially trained classification model 614 without any user-specific data (e.g., payer name, payee name, amount, date, etc.).

Three embodiments for further training classification model 614 may emerge, although the scope of the disclosure is not limited to these embodiments:

1. Training classification model 614 with images 604 associated (e.g., labeled) with financial instrument type alone (and optionally metadata 605). The resulting classification model 614 may provide, in response to receiving an image of a financial instrument, a financial instrument type determination (usually the most likely and/or one of the most likely financial instrument types) and/or an associated financial instrument type confidence score indicating a likelihood the financial instrument type determination is correct. In such embodiments, the resulting classification model 614 may be a multi-class classification model. In some embodiments, the resulting image classification model 614 may provide a financial instrument type confidence score for any financial instrument type determination that surpassed a threshold confidence, set within image classification model 614 (e.g., classification model 614 may provide: certified check—0.6; cashier's check—0.4, when the threshold confidence=0.3). In some embodiments, multiple financial instrument type determinations and associated confidence scores provided by classification model 614 may be considered and/or compared (e.g., by mobile banking app 304 or other program within cloud banking system 316/third party systems) to determine whether a financial instrument type determination is conclusive.

2. Training classification model 614 with images associated (e.g., labeled) with financial instrument type acceptability alone (and optionally metadata 605). The resulting classification model 614 may provide, in response to receiving an image of a financial instrument, a financial instrument type acceptability determination (e.g., acceptable/impermissible type) and/or an associated financial instrument type acceptability confidence score indicating a likelihood the financial instrument type acceptability determination is correct. In such embodiments, the resulting classification model 614 may be a binary classification model. As noted above, the resulting classification model 614 may provide a financial instrument type acceptability confidence score for both acceptable and impermissible determinations for a given image (e.g., acceptable—0.9; impermissible—0.1).

3. Training classification model 614 with images associated (e.g., labeled) with financial instrument type and financial instrument type acceptability (and optionally metadata 605). In some embodiments, this may enable two separate classifiers to be trained. The resulting classification model 614 may provide, in response to receiving an image of a financial instrument, a financial instrument type determination (usually the most likely and/or one of the most likely financial instrument types) and/or an associated financial instrument type confidence score indicating a likelihood the financial instrument type determination is correct. In addition, the resulting classification model 614 may provide, in response to receiving the image of the financial instrument, a financial instrument type acceptability determination (e.g., acceptable/impermissible type) and/or an associated financial instrument type acceptability confidence score indicating a likelihood the financial instrument type acceptability determination is correct. In such embodiments, the resulting classification model 614 may be a multi-label classification model. In some embodiments, any configuration of confidence scores as described above for multi-class classification model 614 and binary classification model 614 separately may be included together in the results of the multi-label classification model 614.

In some embodiments in which classification model 614 is a multi-label classification model, the financial instrument type acceptability determination and/or associated confidence score may be used to determine whether a deposit should proceed, while the financial instrument type determination and/or associated confidence score may be used as information to be communicated to the customer (e.g., “You are attempting to deposit a money order”) and/or to guide a customized validation protocol.

As discussed herein, the embodiments of the present disclosure can be implemented with documents other than financial instruments. Accordingly, in some embodiments, the financial instrument type data described above—which may include the financial instrument type determination, financial instrument type confidence score, financial instrument type acceptability determination, and/or financial instrument type acceptability confidence score—may also be more broadly document type data, which may include a document type determination, document type confidence score, document type acceptability determination, and/or document type acceptability confidence score. Any reference to financial instrument type or financial instrument type acceptability (e.g., in labeling training data and/or receiving outputs from classification model 614) may be understood to more broadly refer to document type or document type acceptability.

In some embodiments in which on-device training of classification model 614 is implemented, categorization module 606 may operate at least partially on client device 302 to label financial instrument images, though categorization module 606 may label financial instrument images at any location within remote deposit system 300 and provide the labels to mobile banking app 304 for on-device training.

In some embodiments, for example, when semi-supervised learning is implemented, the operations of categorization module 606 may be at least partially integrated into a partially trained classification model 614. For example, the partially trained classification model 614, which has been trained on manually and/or automatically labeled data (as described above), may further label additional images of images 604 and use the self-labeled images 604 in training.

Classification model 614 may be further trained using any of the following example ML algorithms, as appropriate for the embodiments discussed herein: linear regression, logistic regression, neural networks, decision tree, support vector machine (SMV), random forest, naive Bayes, k-nearest neighbor (k-NN), and approximate nearest neighbor (ANN).

In some embodiments, for example, when a k-NN or ANN algorithm is used to train classification model 614, classification model 614 may be configured to perform a comparison of a user image 616 with training images (e.g., type 1 images 608, type 2 images 610, . . . type N images 612) and determine a classification of user image 616 based on the comparison. For example, classification model 614 may be configured to identify one or more training images that are most similar to user image 616 (e.g., nearest neighbor(s)), and predict the classification of user image 616 based on the categorization data associated with the identified one or more training images. In some embodiments, classification model 614 may provide a confidence score associated with the predicted classification that is based on both the categorization data associated with the identified one or more training images and the similarity of the user image 616 with the identified one or more training images.

In some embodiments, the comparison of user image 616 and training images may be performed even if no or minimal metadata 605 is used to further train classification model 614, for example, by comparing pixel data alone (e.g., a pixel-by-pixel comparison) or pixel data and exposure related metadata.

In the example of a k-NN or ANN trained model, in some embodiments, the most similar training image(s) may be identified based on the Euclidean distance between images as mapped onto a feature space, where the dimensions of the feature space may be features learned by classification model 614 (e.g., based on input pixel and/or metadata) and position in the feature space is determined by the values of the features for a given image. Alternatively, or in addition, the most similar training image(s) may be identified based a summation of differences between pixel data of corresponding pixels of two images (L1 distance metric or Euclidean). Any distance metric may be used, for example, Euclidean, Manhattan, Minkowski, Chebychev, or Cosine Similarity. While k-NN and ANN algorithms are discussed above, any ML algorithm may be used to train classification model 614 for performing image comparisons, which may include pixel-by-pixel and/or metadata comparisons.

When further trained, classification model 614 may be an ML model configured to determine a type 620 (e.g., a financial instrument type determination as discussed above), a type acceptability 622 (e.g., a financial instrument type acceptability determination as discussed above), and/or associated confidence score(s) 624 (e.g., a financial instrument type confidence score and/or a financial instrument type acceptability confidence score as discussed above) of a financial instrument depicted in an image. In some embodiments, the further trained classification model 614 may be configured to provide type(s) 620, type acceptability 622, and/or associated confidence score(s) 624 in response to being provided (e.g., via an API) a user image 616 and/or associated metadata 618.

In some embodiments, user image 616 may be an image of a financial instrument captured by a customer of mobile banking app 304 using a client device 302. In some embodiments, user image 616 may more broadly be an image of a user document captured using client device 302. In some embodiments, user image 616 may include pixel data such as that described above for images 604. The determination of the type of a financial instrument depicted in user image 616 and/or the determination of the acceptability of the type of the financial instrument depicted in user image 616 may be based on the pixel data. In some embodiments, the determination of the type of a financial instrument depicted in user image 616 and/or the determination of the acceptability of the type of the financial instrument depicted in user image 616 may further be based on metadata 618. Metadata 618 may include values for any one or a combination of the parameters identified above for metadata 605. Additionally, metadata 618 may be associated with and/or linked with user image 616 in the same manner metadata 605 may be associated with and/or linked with images 604, as described above.

While the above description discusses the use of image metadata in the further training and implementation of classification model 614, in some embodiments, classification model 614 may be further trained and implemented using no metadata (i.e., only using pixel data). In such embodiments, metadata may still be included with images 604 and/or user image 616 (e.g., to identify or otherwise process a financial instrument image), but classification model 614 need not consider the metadata in further training or determining financial instrument type/financial instrument type acceptability.

The classification of user image 616 may be performed for any document (e.g., identification document) in the same manner as described herein for a financial instrument.

In some embodiments, classification model 614 may be further trained on a remote platform (e.g., ML platform 329) and implemented at a mobile ML platform on a client device (e.g., mobile ML platform 310). In some embodiments, classification model 614 may be further trained and implemented at ML platform 329. In some, classification model 614 may be further trained and implemented at mobile ML platform 310. In some embodiments, classification model 614 may be initially further trained at ML platform 329, implemented at mobile ML platform 310, and continuously trained at mobile ML platform 310. In some embodiments, classification model 614 may be further trained and/or implemented at a third-party server. In some of such embodiments, providing data (e.g., images) to further trained classification model 614 may include providing the data to an API or other intermediary software implemented on the third party server that then provides the data to the further trained classification model 614. Likewise, receiving data (e.g., financial instrument type data) from the further trained classification model 614 may include receiving data from the API or other intermediary software that is in communication with the further trained classification model 614.

Continuous training of classification model 614 may be performed at ML platform 329, mobile ML platform 310, and/or a third party server. In some embodiments, continuous training of classification model 614 may include providing to classification model 614 a user image 616 (with or without metadata 618), receiving from classification model 614 type(s) 620, type acceptability 622, and/or confidence score(s) 624, and forwarding the user image 616 for validation. In some embodiments, the continuous training may further include determining the result of the validation (e.g., impermissible financial instrument type), labeling user image 616 according to the result (e.g., using categorization module 606), and providing the labeled user image 616 (with or without metadata 618) back to classification model 614 for training.

In some embodiments, user image 616 may be forwarded for validation regardless of the type/type acceptability determined by classification model 614, for example, to generate more training data. In alternative embodiments, user image 616 may be forwarded for validation only in response to the results of classification model 614 indicating user image 616 depicts an acceptable financial instrument type, for example, as part of a standard remote deposit process implementing classification model 614.

In some embodiments, the labeled user image 616 may be provided back to classification model 614 for training regardless of the result of the validation. In some embodiments, user image 616 may be labeled and provided back to classification model 614 for training only if the result of the validation disagrees with classification model 614's prediction. For example, labeled user image 616 may be provided back to classification model 614 for training if classification model 614 indicated user image 616 depicted an acceptable financial instrument type, but user image 616 failed validation due to depicting an impermissible financial instrument type. In such embodiments, classification model 614 may be refined by continuous training using outliers which represent weaknesses in classification model 614. Accordingly, classification model 614 may be refined while minimizing processing costs associated with labeling and providing every user image 616 to classification model 614 for continuous training.

In embodiments in which classification model 614 may be continuously trained at mobile ML platform 310, a refined version of classification model 614 may be implemented without a customer needing to download a new of version of mobile banking app 304. In embodiments in which classification model 614 may be continuously trained at ML platform 329, a customer may need to download a new version of mobile banking app 304 to implement a refined version of classification model 614, which may be bundled with the new version of mobile banking app 304.

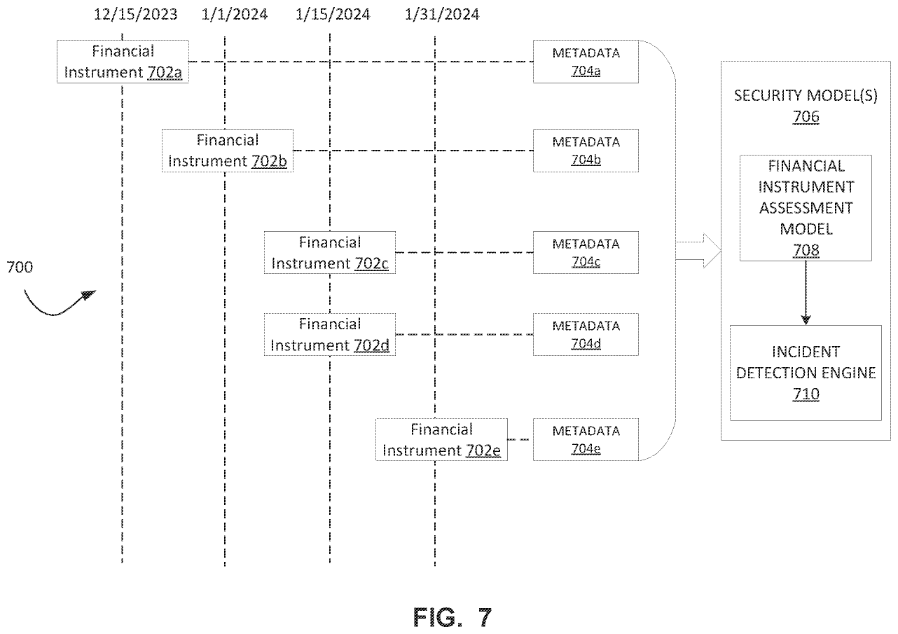

FIG. 7 illustrates a deposit security system including deposit pattern analysis infrastructure for an example customer deposit pattern 700, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 7, as will be understood by a person of ordinary skill in the art.

In some embodiments, the customer deposit pattern 700 may include a plurality of financial instruments 702, for example, financial instrument 702a, financial instrument 702b, financial instrument 702c, financial instrument 702d, and financial instrument 702e. The plurality of financial instruments may each be associated with a date, for example, an issue date. As used herein, “issue date” refers to a date printed or written on the financial instrument that indicates the date the payer authorizes funds to be transferred from the payer to the payee. As shown in FIG. 7, financial instrument 702a may be associated with an issue date of Dec. 15, 2023, financial instrument 702b may be associated with an issue date of Jan. 1, 2024, financial instruments 702c-d may be associated with an issue date of Jan. 15, 2024, and financial instrument 702e may be associated with an issue date of Jan. 31, 2024. However, financial instruments 702 may be associated with any issue dates. While the issue date is specifically identified herein, other dates associated with a financial instrument 702 may be used, such as the date the financial instrument 702 is provided for remote deposit. Financial instruments 702 may represent financial instruments that have been provided by a customer for mobile deposit over a given time period.

In some embodiments, each of financial instruments 702 may be associated with metadata 704. Metadata 704 may include one or more of OCR identified data (e.g., MICR line, date), and type information (e.g., a type determination and/or confidence score obtained from classification model 614). In some embodiments, metadata 704 may be compiled into a metadata file that may be stored and/or transferred with an image or images of a financial instrument or by itself. As shown in FIG. 7, financial instrument 702a may be associated with metadata 704a, financial instrument 702b may be associated with metadata 704b, financial instrument 702c may be associated with metadata 704c, financial instrument 702d may be associated with metadata 704d, and financial instrument 702e may be associated with metadata 704e.

As shown in FIG. 7, metadata 704 may be transferred to a security model 706, such as a financial instrument assessment model 708. In some embodiments, metadata 704 may be transferred to financial instrument assessment model 708 via a database (DB), such as DB 810 shown in FIG. 7. In some embodiments, financial instrument assessment model 708 may include a software implemented algorithm that analyzes metadata 704 to recognize patterns and/or perform comparisons. For example, in some embodiments, financial instrument assessment model 708 may determine one or more financial instrument type parameters associated with a payee customer, based on type information. A financial instrument type parameter may represent a mobile deposit financial instrument type pattern and/or frequency. Likewise, in some embodiments, financial instrument assessment model 708 may determine one or more financial instrument type-specific date parameters, based on dates.

Financial instrument assessment model 708 may identify, from a plurality of financial instruments 702 (images of which have been analyzed as described above), a plurality of financial instruments of a common type. In some embodiments, financial instrument assessment model 708 may determine a financial instrument type parameter for each type of financial instrument identified from a plurality of financial instruments 702. In some embodiments, a financial instrument type parameter may include a number of financial instruments of a specific type attempted to be deposited by a payee customer within a time period. For example, a financial instrument type parameter associated with traveler's checks may be the number of traveler's checks the payee customer has attempted to deposit within the past year (as of the current date). The time period can be any time period. For example, the time period can be the past 10 days, the past 30 days, the past 60 days, the past 90 days, the past calendar month, etc.

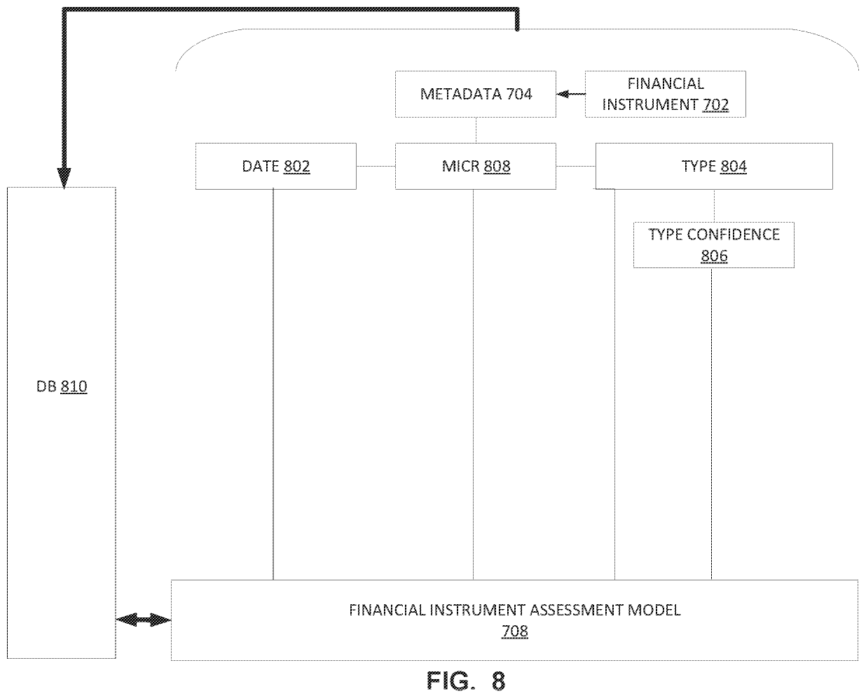

Other embodiments of a financial instrument type parameter are contemplated. For example, a financial instrument type parameter may be the percentage of all financial instruments attempted to be deposited within a time period that are of a specific type. For example, a financial instrument type parameter associated with money orders may be 5% (indicating 5% of attempted deposits were money orders within a given time period). In some embodiments, a financial instrument type parameter may be a combination of the two embodiments discussed above. Regardless of its exact form, a financial instrument type parameter may indicate a frequency of attempted deposit of a certain financial instrument type by a payee customer. Also, as noted herein, the embodiments of the present disclosure may be implemented with documents other than financial instruments. Accordingly, the financial instrument type parameter may be a document type parameter indicating past user patterns related to the submission of any type of document (e.g., past types of identification documents provided for an identity verification process). The specific features of a financial instrument type parameter disclosed herein should be understood to apply to a document type parameter more generally. The embodiments of FIGS. 7-8 may be applied with any type of document 702, not just financial instruments 702, such that financial instrument assessment model 708 can be a document assessment model 708.

In some embodiments, financial instrument assessment model 708 may sort financial instruments provided for deposit by the payee customer. In some embodiments, financial instrument assessment model 708 may recognize when a threshold number of financial instruments of a specific type have been attempted to be deposited within a predetermined time period. In some embodiments, the threshold number can range from 3 to 50 financial instruments, including subranges, within any predetermined time period. For example, in some embodiments, the threshold number can range from 5 to 40 financial instruments, from 5 to 30 financial instruments, from 5 to 20 financial instruments, from 5 to 15 financial instruments, or from 5 to 10 financial instruments, within any predetermined time period. For each of the ranges above, the predetermined time period may range from 1 month to 2 years, including subranges. For example, in some embodiments, the predetermined time period may range from 1 month to 1.5 years, from 1 month to 1 year, from 1 month to 9 months, from 1 month to 6 months, or from 1 month to 3 months. In some embodiments, when the threshold number of financial instruments of the specific type has been met, financial instrument assessment model 708 may provide a notification. The notification may be received by mobile banking app 304 and/or validation module 326 and may be used to update permissions associated with the payee customer. For example, in some embodiments, the specific type of financial instrument may be updated from an impermissible financial instrument type to an acceptable financial instrument type for the payee customer within remote deposit system 300. While the threshold number of financial instruments was being met, feature detection program(s) 526 may have been gathering data on the features of impermissible financial instruments of the specific type so that a validation system (e.g., validation system 900) may now be prepared to process images of the previously impermissible financial instrument type.

In some embodiments, financial instrument assessment model may determine one or more financial instrument type-specific date parameters. In some embodiments, financial instrument assessment model 708 may determine a financial instrument type-specific date parameter for each type of financial instrument it identifies within financial instruments 702 (or any collection of financial instruments 702). A financial instrument type-specific date parameter may be determined based on issue date information included in metadata 704 (e.g., extracted via OCR processing, such as active and/or instant OCR). A financial instrument type-specific date parameter may be determined based on a length of time between the issue dates of financial instruments of a specific type submitted for deposit by the payee customer. For example, in some embodiments, financial instrument assessment model 708 may determine that, on average, treasury checks submitted for deposit by the payee customer are issued about every 15 days. Variability may exist; for example, financial instrument assessment model 708 may determine that financial instrument 702b (which may be a treasury check in this example), issued, as an example, on Jan. 1, 2024, was issued 17 days after financial instrument 702a (which may also be a treasury check in this example), issued, as an example, on Dec. 15, 2023. In contrast, financial instrument assessment model 708 may determine that financial instrument 702c (which may also be a treasury check in this example), issued, as an example, on Jan. 15, 2024, was issued 14 days after financial instrument 702b. These timeframes are exemplary; financial instrument assessment model 708 may determine any average time between the issuance of financial instruments of a common type.

In some embodiments, a financial instrument type-specific date parameter may be determined by analyzing images of financial instruments (e.g., to obtain issue date data) that are submitted for deposit by a single customer.

In some embodiments, a financial instrument type-specific date parameter may indicate an expected range of dates of issuance of a financial instrument of a specific type, as determined from deposit attempts by the payee customer. For example, a financial instrument type-specific date parameter may be a timeframe in which it is expected, based on past deposit patterns, that a single financial instrument of the specific type will be issued. In some embodiments, the timeframe may be measured from the issue date of the last financial instrument of the specific type that has been attempted to be deposited. Accordingly, in some embodiments, a financial instrument type-specific date parameter may be a range of a number of days, for example, 14-17 days. But the range of the number of days is likely different depending on the specific financial instrument type. For example, a range for a treasury check may be approximately 365 days (e.g., for a customer who submits a tax return check each year), while a range for a personal check may be 10-20 days.

In some embodiments, a financial instrument type-specific date parameter may be determined by financial instrument assessment model 708 using statistical analysis. For example, a financial instrument type-specific date parameter may be determined by calculating a mean time (e.g., number of days) between financial instrument issuances of a specific financial instrument type and setting the financial instrument type-specific date parameter to include any date within one standard deviation (or within more standard deviations) of the mean time. In some embodiments, the financial instrument type-specific date parameter may simply be the mean time.

Since the standard deviation is a measure of the variability of data, a high standard deviation may indicate that financial instruments, though of a specific type, are not likely to be associated with regular deposit patterns. Likewise, a low standard deviation may indicate that financial instruments of a specific type correspond with regular deposit patterns (e.g., paycheck deposits). In some embodiments, the standard deviation of the times between financial instrument issuances for a specific financial instrument type may be used in a security assessment, as described below. For example, if a customer attempts to deposit a financial instrument of a type that is associated with a high standard deviation (irregular deposit patterns), a confidence score indicating a likelihood the financial instrument is legitimate (e.g., not fraudulent) may be adjusted downward, and vice-versa (low standard deviation indicates regular deposit patterns). Alternatively or additionally, a confidence score indicating a likelihood the financial instrument is illegitimate (e.g., fraudulent) may be adjusted upward, and vice-versa. Further, the standard deviation of the times between financial instrument issuances for a specific financial instrument type may be used to modulate the weight an associated financial instrument type-specific date parameter is given when a date of a financial instrument being deposited by a customer is compared to the financial instrument type-specific date parameter (described below). Financial instrument assessment model 708 may be configured to alter weights to account for the fact that deviation from a well-established pattern may represent suspicious deposit activity more than deviation from a loose pattern.

In some embodiments, a financial instrument type-specific date parameter may only be used once a predetermined threshold number of deposits have been used to determine the parameter. For example, in some embodiments, the predetermined threshold number may be 3, 5, 10, 20, 50, 100, or any appropriate number that ensures the parameter is reasonably representative of past deposit patterns. In some embodiments, the financial instrument type-specific date parameter may be determined only from previous deposit attempts that were successful (e.g., posed no or minimal security risk as determined by one or more security model(s) 706).

While determination of a financial instrument type-specific date parameter using issue dates has been described, in some embodiments, submission dates (e.g., the date a customer is submitting a document for mobile deposit or identity verification) may be used.

Once financial instrument assessment model 708 has determined one or more financial instrument type parameters and/or one or more financial instrument type-specific date parameters, financial instrument assessment model 708 may identify any financial instrument type parameter based on metadata 704 associated with any future financial instrument 702 and/or compare metadata 704 associated with any future financial instrument 702 to any financial instrument type-specific date parameter. For example, financial instrument assessment model 708 may identify a financial instrument type parameter based on type information included in metadata 704. Similarly, financial instrument assessment model 708 may identify a financial instrument specific-type parameter based on the type information and compare a date associated with a financial instrument 702 (e.g., the issue date) to a financial instrument type-specific date parameter. Financial instrument assessment model 708 may determine a level of correspondence of the date associated with the financial instrument 702 with the financial instrument type-specific date parameter. The financial instrument type parameter and/or the level of correspondence may at least partially determine a confidence score, as discussed in more detail below.

In some embodiments, financial instrument assessment model 708 may provide the confidence score to incident detection engine 710, which may determine whether the confidence score meets a predetermined threshold. By “meet” a predetermined threshold, it should be understood that the confidence score may be a score indicating a likelihood a deposit attempt is legitimate (e.g., not fraudulent), or may be a score indicating a likelihood a deposit attempt is illegitimate (e.g., fraudulent). Accordingly, in the first case, “meeting” a predetermined threshold may include being below a predetermined threshold. In the second case, “meeting” a predetermined threshold may include exceeding a predetermined threshold. Both cases are contemplated. In both cases, the confidence score may be associated with whether a deposit attempt is illegitimate (e.g., fraudulent).

Incident detection engine 710 may receive inputs from other security model(s) 706, which may include ML security assessment models that analyze customer historical data, OCR data, etc. Based on the confidence score and/or the inputs, for example, in response to the confidence score meeting a predetermined threshold, incident detection engine 710 may determine that a deposit attempt should be denied. In some embodiments, this determination may be provided to a payee customer in real-time as a document acceptance status 416. In response to incident detection engine 710 determining that the confidence score does not meet a predetermined threshold, incident detection engine 710 may determine that further assessment of the security of the deposit attempt is required. In some embodiments, this determination may also be provided to a payee customer in real-time as a document acceptance status 416. In such embodiments, the document acceptance status 416 may display to the payee customer a notification that the deposit attempt has been denied and in-person deposit is required, or that the deposit attempt has been accepted but the customer should retain the financial instrument for a few days. This may allow for the further security assessment to be conducted, for example, at a backend server.

In some embodiments, financial instrument assessment model 708 and incident detection engine 710 may be implemented on client device 302, for example, as part of mobile banking app 304. In some embodiments, financial instrument assessment model 708 and incident detection engine 710 may be implemented at cloud banking system 316 and/or at a third-party server. In both cases, metadata 704 may be provided to financial instrument assessment model 708 after being gathered by OCR program(s) 522, OCR ML model 524, and/or classification model 614 that may each either be implemented at client device 302 or a backend system (e.g., cloud banking system 316 and/or a third party server). In both cases, in some embodiments, the results of financial instrument assessment model 708 and incident detection engine 710 may be output in real time (e.g., within a current customer transaction period before the payee customer submits a deposit request or immediately after in response to the payee customer submitting the deposit request). Alternatively, in some embodiments, the results of financial instrument assessment model 708 and incident detection engine 710 may be provided substantially after a payee customer submits a deposit request, for example, within a day or more of the deposit request submission. In some embodiments, financial instrument assessment model 708 and incident detection engine 710 may be implemented as part of a standard, non-real-time security assessment performed on a deposit request.

In some embodiments, the outputs of financial instrument assessment model 708 and/or incident detection engine 710 may be provided to funds availability platform 412 to be factored into a funds availability schedule determination. For example, in some cases, the more a deposit request conforms to preexisting financial instrument type deposit patterns, the faster funds may be released to a payee customer.

In some embodiments, rather than providing a confidence score, financial instrument assessment model 708 may determine that the financial instrument 702 presents a high risk of fraud (i.e., is likely counterfeit), and indicate the high risk of fraud to incident detection engine 710. In response, incident detection engine 710 may determine that the financial instrument may not be deposited via remote deposit.

As described herein, a message indicating the results determined by financial instrument assessment model 708 and/or incident detection engine 710 may be provided to the customer via UI 306.

FIG. 8 illustrates an example flow diagram for processing a financial instrument 702. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 8, as will be understood by a person of ordinary skill in the art.

Financial instrument 702 in FIG. 8 may be any financial instrument that is being processed to determine a financial instrument type parameter and/or financial instrument type-specific date parameter, based on metadata 704. Alternatively, or in addition, financial instrument 702 of FIG. 8 may be a financial instrument that is being processed to identify a financial instrument type parameter and/or determine a level of correspondence of a date 802 with a financial instrument type-specific date parameter. In some embodiments, financial instrument 702 may be both. That is, data associated with financial instrument 702 (e.g., metadata 704) may be used to determine or refine the financial instrument type parameter and/or financial instrument type-specific date parameter, and the associated data may also be compared to data associated with previous financial instrument to identify a financial instrument type parameter and/or determine a level of correspondence of a date 802 with a financial instrument type-specific date parameter as described above.

As shown in FIG. 8, data associated with financial instrument 702 may be in the form of metadata 704. In some embodiments, metadata 704 may include one or more of date 802 (e.g., issue date or submission date), type 804 (e.g., from type(s) 620 output by classification model 614), type confidence 806 (e.g., a confidence score 624 indicating a likelihood type 804 is correct), and MICR 808 data. MICR 808 data may optionally be included to assist financial instrument assessment mode 708 in determining financial instrument type parameters and financial instrument type-specific date parameters that are specific to certain payers (e.g., as identified from an account number in MICR 808 data). Accordingly, in some embodiments, a financial instrument type parameter and/or a financial instrument type-specific date parameter may be payer-specific.

In some embodiments, one or more images of financial instrument 702 may be stored in a DB 810. In some embodiments, no image of financial instrument 702 may be stored in DB 810, but metadata 704 without an image may be stored. DB 810 may be any suitable form of database, such as a hierarchical database, a network database, an object-oriented database, a relational database, a cloud database, a centralized database, and/or a NoSQL database. In some embodiments, DB 810 may reside on cloud banking system 316, for example, as part of file DB 320. In some embodiments, DB 810 may reside on client device 302 as part of client device 302's internal storage. In some embodiments, metadata 704 may be stored in a metadata file, which may be linked to the image of financial instrument 702 and/or a deposit request and stored in DB 810. The metadata file may include one or more of the items indicated in FIG. 7.

As shown in FIG. 7, financial instrument assessment model 708 may communicate with DB 810 to retrieve and store data. For example, in some embodiments, financial instrument assessment model 708 may communicate with DB 810 to retrieve metadata associated with one or more financial instrument images, and may retrieve and store parameters determined by financial instrument assessment model 708 based on the metadata. In some embodiments, a portion of financial instrument assessment model 708 may determine the parameters based on data in DB 810 (which may be stored at cloud banking system 316 and/or a third party server) and may communicate the parameters to mobile banking app 304 (e.g., from a backend server). Then, another portion of financial instrument assessment model 708 operating within mobile banking app 304 may perform comparisons of metadata 704 (with or without storing the metadata 704 in DB 810) of future financial instruments 702 with the parameters. Accordingly, in some embodiments, financial instrument assessment model 708 may be distributed across a backend server and mobile banking app 304.

In some embodiments, an image of a financial instrument 702 may be captured using camera 308 and processed using image processing system 520 and classification model 614, and associated data fields (e.g., metadata 704) may be stored in DB 810. Financial instrument assessment model 708 may retrieve metadata 704 to compare it with past metadata associated with images of financial instruments provided by the payee customer and/or to determine parameters. In some embodiments, financial instrument assessment model 708 may retrieve metadata 704 of a financial instrument 702 from DB 810 in response to instructions from mobile banking app 304, which has initiated a mobile deposit of the financial instrument 702. In some embodiments, the instructions may include an identifier associated with financial instrument 702 and a location of metadata 704 associated with financial instrument 702 in DB 810.

In some embodiments, once financial instrument assessment model 708 retrieves metadata 704, financial instrument assessment model 708 may determine, based on type 804, that financial instrument 702 is a specific type of financial instrument. Financial instrument assessment model 708 may then identify and retrieve a financial instrument type parameter and/or a financial instrument type-specific date parameter associated with the specific type. Financial instrument assessment model 708 may then compare date 802 to the financial instrument type-specific date parameter. Based on the financial instrument type parameter and/or the comparison of date 802 to the financial instrument type-specific date parameter, financial instrument assessment model 708 may compute a confidence score. In some embodiments, the confidence score may correlate to a value of the financial instrument type parameter (e.g., more financial instruments of a specific type within a time period produces a higher confidence score if the confidence score is a score indicating the likelihood a financial instrument is legitimate (e.g., non-fraudulent), or a lower confidence score if the confidence score is a score indicating the likelihood a financial instrument is illegitimate (e.g., fraudulent)). Additionally or alternatively, the confidence score may correlate to a level of correspondence of date 802 with the financial instrument type-specific date parameter. Accordingly, the confidence score may indicate the level of correspondence of the type of a given financial instrument 702 with past deposit patterns, as they relate to financial instrument types. Higher correspondence may indicate a financial instrument is legitimate. The confidence score may either be a score indicating a likelihood a financial instrument is not fraudulent (e.g., not counterfeit) or fraudulent (e.g., counterfeit).

In some embodiments, for a given financial instrument 702 associated with a payee customer, financial instrument assessment model 708 may compute the confidence score based on one or more of the following non-limiting factors:
1. The value (e.g., a number or percentage, as described herein) of a financial instrument type parameter corresponding to type 804 of the given financial instrument 702; and
2. Whether date 802 falls within a financial instrument type-specific date parameter corresponding to type 804 of the given financial instrument 702 and/or the difference between date 802 and the center point of the financial instrument type-specific date parameter;
3. Type confidence 806. In some embodiments, type confidence 806 may be used to adjust the weight with which type 804 of the given financial instrument 702 is treated by financial instrument assessment model 708. For example, financial instrument assessment model 708 may be configured to weight the value of the financial instrument type parameter and/or the comparison of date 802 with the financial instrument type-specific date parameter based on type confidence 806. If type confidence is low, the type 804 of the given financial instrument 702 cannot be relied upon as heavily when determining whether the given financial instrument 702 corresponds with past payee customer deposit activity. In some embodiments, if multiple types 620 are included in type 804 and multiple confidence scores 624 associated with the types 620 are included in type confidence 806, financial instrument assessment model 708 may be configured to identify multiple financial instrument type parameters and/or multiple financial instrument type-specific date parameters (each corresponding to a type 620) and perform multiple comparisons, the financial instrument type parameters and/or comparisons optionally weighted according to the confidence scores 624.

In some embodiments, financial instrument assessment model 708 may be configured to perform single operations, including one of the following:
Identifying a financial instrument type parameter and determining a confidence score based on the parameter; and
Identifying a financial instrument type-specific date parameter and comparing date 802 to the financial instrument type-specific date parameter, and determining a confidence score based on the level of correspondence of date 802 with the financial instrument type-specific date parameter.

Financial instrument assessment model 708 may include logic for performing any one or both of the above operations. While FIG. 7 shows metadata 704 including date 802, type 804, type confidence 806, and MICR 808 data, in some embodiments, metadata 704 may include date 802 and type 804, without one or all of the remaining items of metadata 704. In some embodiments, metadata 704 may include just type 804, for example, when just the first operation listed above is performed. In such embodiments, financial instrument type parameters need not be tied to a specific time period, but may be based on all deposit attempts by a payee customer.

In some embodiments, financial instrument assessment model 708 may be implemented on one or more processors of client device 302, cloud banking system 316, or a third party platform. In some embodiments, financial instrument assessment model 708 may be implemented on an edge server within cloud banking system 316.

In some embodiments, financial instrument assessment model 708 be a rule-based algorithm. In some embodiments, financial instrument assessment model 708 may be a ML model. For example, in such embodiments, financial instrument assessment model 708 may be an ML model trained on metadata 704 and/or images of financial instruments 702. In such embodiments, financial instrument assessment model 708 may be trained using supervised learning, in which images of financial instruments 702 that have been deposited by one or more customers may be provided to an untrained or partially trained version of financial instrument assessment model 708 and may be labeled as fraudulent or non-fraudulent. In some embodiments, the images of financial instruments 702 may be provided to the untrained or partially trained financial instrument assessment model 708 with one or more items of metadata 704, and optionally parameters as discussed herein for one or more customers. As a result, a ML financial instrument assessment model 708 may provide a confidence score indicating a likelihood a financial instrument 702 is fraudulent (or non-fraudulent) in response to an image of financial instrument 702, metadata 704, and/or one or more parameters being provided to the ML financial instrument assessment model 708. In such embodiments, the ML financial instrument assessment model 708 may be trained on ML platform 329 and/or mobile ML platform 310 and may be run on ML platform 329, mobile ML platform 310, or a third-party server.

As noted herein, financial instrument assessment model 708 may be a document assessment model 708 more generally configured to assess any type of document (e.g., a type of an identification document) based on document type. Accordingly, in some embodiments, type 804 may be the type of an identification document and date 802 may be the date the identification document is provided as part of an access request. Additionally, a document assessment model 708 may compute a confidence score associated with whether an image of an identification document is fraudulent, the confidence score being based at least on a document type parameter and/or type confidence 806, as described above for a financial instrument.

FIG. 9 illustrates an example diagram of a validation system 900, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 9, as will be understood by a person of ordinary skill in the art.

As shown in FIG. 9, validation system 900 may include feature data database (DB) 902. In some embodiments, feature data DB 902 may store results from feature detection program(s) 526, OCR program(s) 522, and/or OCR ML model 524. Feature data DB 902 may be any suitable form of database, such as a hierarchical database, a network database, an object-oriented database, a relational database, a cloud database, a centralized database, and/or a NoSQL database. In some embodiments, feature data DB 902 may reside on cloud banking system 316, for example, as part of file DB 320. In some embodiments, feature data DB 902 may reside on client device 302 as part of client device 302's internal storage. In some embodiments, the results of feature detection program(s) 526, OCR program(s) 522, and/or OCR ML model 524 may be aggregated and stored by financial instrument type within feature data DB 902. For example, for each type of financial instrument or other document, feature data DB may store data on one or more of dimensions 904 (e.g., real-world dimensions), color data 906, text content 908, boundary profile 910, feature location 912, and typeface 914. In some embodiments, data may include averages, medians, ranges, and/or other statistics on values gathered from multiple images of a certain financial instrument type or other document type. Alternatively, or in addition, data may include percentages of images of a certain financial instrument type or other document type that included a specific feature.

In some embodiments, feature data in DB 902 may be collected from images provided by a single user, for example, a payee customer or other user during remote deposit or remote access processes. In some embodiments, for example, when feature data DB 902 is implemented on cloud banking system 316 or a third-party server, feature data in DB 902 may be collected from images provided by multiple users, for example, multiple payee customers or other users during remote deposit or remote access processes. In some embodiments, feature data in DB 902 may be collected from images from another database (e.g., an online database) which have not been provided by any customers of mobile banking app 304. In such embodiments, the feature data may be obtained using feature detection program(s) 526, OCR program(s) 522, OCR ML model 524, and/or by manual observation.

In some embodiments, validation system 900 may implement a validation protocol 916. The validation protocol 916 may be a standard series of processes validation system 900 performs to validate an image. In some embodiments, the validation protocol 916 may include image analysis protocol(s) 918. Image analysis protocol(s) 918 may include image quality checks, OCR processing, etc.

In some embodiments, in response to a financial instrument type determination (e.g., type(s) 620) and/or a financial instrument type acceptability determination (e.g., type acceptability 622) indicating a financial instrument being deposited by a payee customer corresponds to an acceptable financial instrument type, remote deposit system 300 may provide an image of the financial instrument (e.g., user image 616) to validation system 900, along with the financial instrument type determination and optionally associated confidence score(s) 624. In some embodiments, validation system 900 may customize a validation protocol 916 based on the financial instrument type determination.

Validation protocol 916 may be customized in a number of ways. In some embodiments, based on color data 906, validation system 900 may select a certain OCR program and/or OCR ML model which performs better for certain hues and/or color intensities. In some embodiments, based on a type of typeface 914, validation system 900 may select a certain OCR program and/or OCR ML model which performs better given the type of typeface 914. In some embodiments, a customized validation protocol 916 may include verifying dimensions 904, the presence of specific text content 908, and/or the shape of a boundary profile 910. In some embodiments, the customized validation protocol 916 may include verifying whether a feature of the financial instrument or other document being deposited corresponds to an expected feature (e.g., color data at a particular location of the financial instrument matches or is at least similar to color data at the corresponding location of previous financial instruments of the same type, a feature of the financial instrument is in the same location as a corresponding feature of previous financial instruments of the same type, etc.).

As another example, in some embodiments, feature location 912 data may be used to direct an image analysis protocol 918 (e.g., OCR processing) to a location of a financial instrument to obtain data about a feature. For example, feature location 912 data may include a location of a feature (e.g., a particular field) on a financial instrument of a particular type or other document of a particular type. In some embodiments, the location may be a real-world location (e.g., relative to the borders of the financial instrument or other document). The customized validation protocol 916 may receive the feature location 912 data and direct an image analysis protocol 918 to the location of the feature, for example, on the financial instrument being deposited based on the type of the financial instrument being deposited. For example, based on information that the check number of a MICR line of one financial instrument type is on the left of the MICR line (as compared to the right), validation protocol 916 may direct an OCR program to look for routing and account information in a different place (e.g., in the bottom center and bottom right of financial instrument) than it usually does. As another example, based on information that date of birth is located in a different place on a license as compared to a passport, validation protocol 916 may direct an OCR program to look for date of birth in different locations depending on the document type. These sorts of customization may make image analysis protocol(s) 918 more efficient. Further, any of the above methods may make image analysis protocol(s) 918 more likely to succeed (i.e., obtain the data they need in order for validation protocol 916 to complete).

While the above examples are provided, validation protocol 916 may be customized based on one or more items of data from feature data DB 902 according to any method. In other words, different validation protocols 916 may be performed for different type(s) 620.

In some embodiments, for example, when multiple types 620 are provided for a single image accompanied by multiple confidence scores 624, validation system 900 may attempt to customize validation protocol 916 based on types 620 sequentially (e.g., starting with the type 620 associated with the highest confidence score 624, and working downward) until validation system 900 finds a customized validation protocol 916 that works. In some embodiments, validation system 900 may customize validation protocol 916 based on multiple types 620 simultaneously. For example, in such embodiments, validation system 900 may customize validation protocol 916 based on feature data from DB 902 associated with multiple types 620, optionally weighting how much the feature data for each type 620 affects the customization of validation protocol 916 based on the associated confidence score 624 for each type.

In some embodiments, validation system 900 may be implemented on cloud banking system 316, for example, as part of validation module 326. In some embodiments, validation system 900 may be implemented on third-party servers. In some embodiments, validation system 900 may be implemented on client device 302 (e.g., image analysis protocol 918 may be performed by image processing system 520). In some embodiments, validation by validation system 900 may be performed in real time (e.g., within a current customer transaction period before the payee customer submits a deposit request or immediately after in response to the payee customer submitting the deposit request). In some embodiments, validation by validation system 900 may be performed substantially after a customer submits a deposit request (e.g., within a day or more).

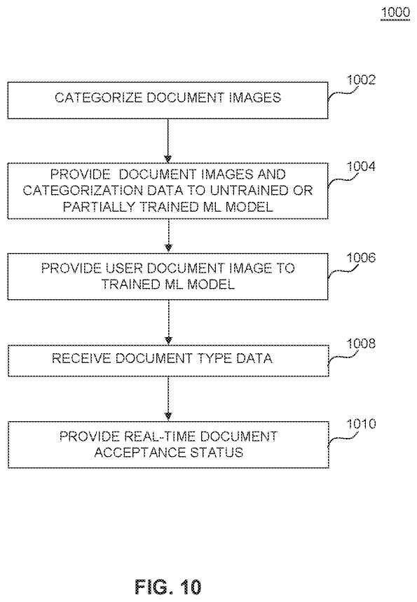

FIG. 10 is a flow chart depicting a training method 1000 that can be carried out in line with the discussion above. One or more of the operations in the method depicted by FIG. 10 could be carried out by one or more entities, including, without limitation, client device 302, cloud banking system 316, or other server or cloud-based server processing systems and/or one or more entities operating on behalf of or in cooperation with these or other entities. Any such entity could embody a computing system, such as a programmed processing unit or the like, configured to carry out one or more of the method operations. Further, a non-transitory data storage (e.g., disc storage, flash storage, or other computer readable medium) could have stored thereon instructions executable by a processing unit to carry out the various depicted operations. In some embodiments, the systems described train and implement a predictive ML model for conducting a real-time document type assessment.

Unless stated otherwise, the steps of method 1000 need not be performed in the order set forth herein. Additionally, unless specified otherwise, the steps of method 1000 need not be performed sequentially. The steps may be performed in a different order or simultaneously. Further, method 1000 may not include all the steps illustrated. For example, in some embodiments, method 1000 may not include step 1010 (e.g., no real-time status need be provided). Likewise, in some embodiments, method 1000 need not include step 1002 and/or 1004 if an already trained model is being implemented. Additionally, in some embodiments, at least a portion of step 1002 need not be performed by a computing device, but may be performed manually (e.g., manually labeling images). Portion(s) of step 1002 that may be performed manually may be omitted from some technical implementations of method 1000.

Step 1002 may include categorizing a plurality of images of documents (e.g., images 604). In some embodiments, step 1002 may include associating categorization data (e.g. label(s)) with each of the plurality of images. In some embodiments, the categorization data may include at least one of a type of a document (e.g., type of financial instrument or type of identification document) or an acceptability of the type of document depicted in an image of the plurality of images. In some embodiments, the plurality of images may include images of personal checks, business checks, cashier's checks, certified checks, traveler's checks, treasury checks, payroll checks, money orders, or any combination thereof. In some embodiments, the type of the document can include a type of a financial instrument. In some embodiments, prior to categorizing the plurality of images in step 1002, method 1000 may include receiving the plurality of images, wherein the plurality of images have been submitted by a plurality of customers of a mobile banking app (e.g., mobile banking app 304). In some embodiments, the categorization data may include an indication of whether the type of the document is acceptable or impermissible such that document type data received from a model trained using the categorization data includes a document type acceptability determination (e.g., as described with respect to FIG. 6).

Step 1004 may include providing the plurality of images and the categorization data to an untrained or partially trained machine learning (ML) model as training data for training the untrained or partially trained ML model.

Step 1006 may include providing an image of a user document (e.g., user image 616) to the trained ML model (e.g., classification model 614 trained using the training data).

Step 1008 may include receiving document type data (e.g., type(s) 620, type acceptability 622, and/or confidence score(s) 624). In some embodiments, the document type data may be received in response to providing the image of the user document to the trained ML model. In some embodiments, the document type data may be received from the trained ML model and/or via an API or other software interface. In some embodiments, the document type data may include a document type determination (e.g., type(s) 620), a document type confidence score indicating a likelihood the document type determination is correct (e.g., confidence score(s) 624), a document type acceptability determination (e.g., type acceptability 622), a document type acceptability confidence score indicating a likelihood the document type acceptability determination is correct (e.g., confidence score(s) 624), or a combination thereof.

In some embodiments, both the plurality of images of documents and the image of the user document may be images of financial instruments, and method 1000 may be implemented in a remote deposit environment. In such embodiments, the document type data may be received in response to providing an image of a deposit financial instrument (corresponding to the “user document”) to the trained ML model and may be financial instrument type data. Furthermore, the document type determination may comprise a financial instrument type determination, the document type confidence score may comprise a financial instrument type confidence score indicating a likelihood the financial instrument type determination is correct, the document type acceptability determination may comprise a financial instrument type acceptability determination, and/or the document type acceptability confidence score may comprise a financial instrument type acceptability confidence score indicating a likelihood the financial instrument type acceptability determination is correct.

Step 1010 may include providing, in real-time via a display (e.g., client device display 506) of a mobile device associated with a user (e.g., mobile computing device 102/client device 302), a document acceptance status (e.g., document acceptance status 416). In some embodiments, the document acceptance status may be related to acceptance of the image of the user document.

In some embodiments of method 1000, the trained ML model may be implemented on the mobile device. In some embodiments, the untrained or partially trained ML model may be trained using the training data on a remote platform (e.g., ML platform 329) and provided to the mobile device. In some embodiments, the mobile device may include a neural processing unit (NPU) to implement the trained ML model.

In some embodiments of method 1000, the trained ML model may be implemented on a remote platform (e.g., ML platform 329).

In some embodiments of method 1000, the document type data may include the document type determination, wherein, in response to the document type determination corresponding to an impermissible document type (e.g., an impermissible financial instrument type or an impermissible identification document type), the document acceptance status may indicate the impermissible document type is not accepted.

In some embodiments of method 1000, the document type data may include the document type confidence score, wherein, in response to the document type confidence score being below a predetermined threshold, the document acceptance status may indicate the image of the user document is not accepted. In some of such embodiments, the document acceptance status may further indicate the user document corresponds to no known document type.

In some embodiments of method 1000, the document type data may include the document type acceptability confidence score, wherein, in response to the document type acceptability confidence score not meeting a predetermined threshold, the document acceptance status may indicate the user document corresponds to an impermissible document type (e.g., an impermissible financial instrument type or an impermissible identification document type). In some embodiments, the document type acceptability confidence score may be a confidence score indicating a likelihood the image of the user document depicts an acceptable document type. In embodiments in which the document type acceptability confidence score is a confidence score indicating a likelihood the image of the user document depicts an impermissible document type, the document acceptance status may indicate the user document corresponds to an impermissible document type in response to the document type acceptability confidence score equaling or exceeding a predetermined threshold.

In some embodiments, method 1000 may include, in response to at least one of the document type determination or document type acceptability determination indicating the user document corresponds to an acceptable document type (e.g., an acceptable financial instrument type or an acceptable identification document type), providing the image of the user document and the document type determination to a validation system (e.g., validation system 900). In some embodiments, method 1000 may include customizing a validation protocol (e.g., validation protocol 916) based on the document type determination. In some embodiments, the customized validation protocol may include verifying whether a feature of the user document corresponds to an expected feature (e.g., dimensions 904, etc.). In some embodiments, method 1000 may include providing feature location (e.g., feature location 912) data to the validation protocol, the feature location data comprising a location of a feature and depending on the document type determination (e.g., which feature location 912 data is provided to the validation protocol depends on a document type 620). In some of such embodiments, the customized validation protocol may include directing an image analysis protocol (e.g., image analysis protocol(s) 918) to the location to obtain data related to the feature.

In some embodiments, method 1000 may include receiving a plurality of images of user documents (e.g., user images 616 of, for example, deposit financial instruments 702). In some embodiments, each of the plurality of images of user documents may include an image of a document (e.g., financial instrument 702a) obtained using the mobile device associated with the user. In some embodiments, method 1000 may include providing the plurality of images of user documents to the trained ML model. In some embodiments, method 1000 may include receiving document type data (e.g., type(s) 620, type acceptability 622, and/or confidence score(s) 624) for each of the plurality of images of user documents. In some embodiments, method 1000 may include determining a document type parameter (e.g., such as that discussed with respect to FIGS. 7-8 determined by financial instrument assessment model 708) associated with the user, the document type parameter being based on the document type data for one or more of the plurality of images of user documents. In some embodiments, method 1000 may include identifying (e.g., by financial instrument assessment model 708), based on document type data (e.g., type(s) 620, type acceptability 622, and/or confidence score(s) 624) associated with the image of the user document, the document type parameter. In some embodiments, method 1000 may include determining (e.g., by financial instrument assessment model 708) a confidence score associated with whether the user document is fraudulent, based on the document type parameter. In some embodiments, the document type parameter may include a number of financial instruments of a specific type attempted to be deposited within a time period.

While the above disclosure describes training and implementing predictive ML model(s) on various types of documents, other types not enumerated or discussed are contemplated. Further, the systems and methods disclosed herein may be used to categorize and identify sub-types of documents that share colors, typeface, location of identifiable fields, or other features. In some embodiments, the sub-types may be specific to a payee customer. In some embodiments, a deep learning model (e.g., a CNN) may be used to generate types. For example, the categorization of financial instrument images into groups of financial instruments with similar features by a deep learning model may be used to identify types via unsupervised learning. In such embodiments, type labels may be applied to images of financial instruments based on an output of the deep learning model. In such embodiments, the labeling process may be fully automated (e.g., provide an image to deep learning model, receive a categorization into one of the types identified by the deep learning model based on other images, and based on the categorization, label the image).

Additionally, while the above disclosure describes basing document type determination and/or document type acceptability determination on a single image, the determination(s) may be made and/or confirmed over the course of providing multiple image frames to a trained ML image classification model. For example, in some embodiments, a document type determination and/or document type acceptability determination may be made and/or confirmed based on a confidence score associated with a classification being above a predetermined threshold for a threshold number of image frames in an image stream. In some embodiments, the image frames may be required to be successive image frames in the image stream.

As noted herein, the embodiments of the present disclosure may be implemented with types of documents other than financial instruments to determine whether an accepted document type is being submitted by a user. For example, a user may attempt to use an identification document, an image of which is captured remotely, to obtain access to a service, product, and/or website. Accordingly, uses of “deposit request” and “requesting a deposit” can be understood to additionally cover an “access request” and “requesting access.” While financial instruments and identification documents are mentioned herein, the embodiments of the present disclosure may be implemented whenever a document type determination may be used to assess whether a document corresponds to an acceptable type. Further, in any of the embodiments of the present disclosure discussed herein, the term “financial instrument” may be replaced with “document” to describe embodiments which are implemented with documents generally, including, for example, identification documents.

The solutions described herein provide technical solutions to shortcomings of current remote deposit image capture processes. The various embodiments solve at least the technical problems associated with predicting, in real-time, whether an image of a financial instrument will be able to be successfully processed because it depicts an acceptable financial instrument type, resulting in a more efficient remote deposit process and user experience. The various embodiments encompassed by the technology disclosed herein are able to provide accurate classifications mid-image capture experience, in some cases before the customer completes the transaction, to avoid requiring the customer to wait to receive a determination on whether a financial instrument is an acceptable type post extensive image quality checks or OCR processing.

Additionally, the solutions described above provide a means of quickly flagging financial instrument images that may pose a security risk. For example, if a comparison of a financial instrument type being deposited by a customer to past financial instrument type deposit patterns reveals little similarity, the financial instrument image(s) may pose a higher security risk. However, if a high level of similarity exists, this may be an indication the transaction poses a low security risk because it is consistent with standard customer behavior.

Additionally, the solutions described herein may aid in customizing validation protocols to better handle different types of financial instruments. For example, using an image processing system, data on features associated with certain financial instrument types may be collected and used to customize validation protocols, and particularly image analysis protocols (e.g., OCR processing) used in the validation. Customizing the validation protocols based on financial instrument type may increase the efficiency and success (e.g., all required information extracted from an image) rate of validation. By analyzing images provided by one or more payee customers to prepare a validation system to better handle various financial instrument types, in some embodiments, repeated attempts to deposit a previously impermissible financial instrument may result in permissions being updated for a payee customer (e.g., previously impermissible financial instrument type now accepted).

### Example Computer System

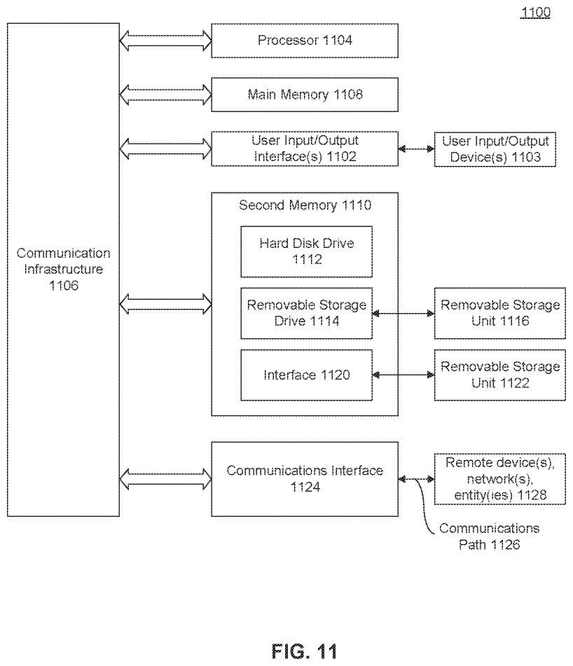

FIG. 11 depicts an example computer system useful for implementing various embodiments.

Various embodiments may be implemented, for example, using one or more well-known computer systems, such as computer system 1100 shown in FIG. 11. One or more computer systems 1100 may be used, for example, to implement any of the embodiments discussed herein, as well as combinations and sub-combinations thereof. For example, the example computer system may be implemented as part of mobile computing device 102, client device 302, cloud banking system 316, etc. Cloud implementations may include one or more of the example computer systems operating locally or distributed across one or more server sites.

Computer system 1100 may include one or more processors (also called central processing units, or CPUs), such as a processor 1104. Processor 1104 may be connected to a communication infrastructure or bus 1106.

Computer system 1100 may also include customer input/output device(s) 1102, such as monitors, keyboards, pointing devices, etc., which may communicate with communication infrastructure 1106 through customer input/output interface(s) 1102.

One or more of processors 1104 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1100 may also include a main or primary memory 1108, such as random access memory (RAM). Main memory 1108 may include one or more levels of cache. Main memory 1108 may have stored therein control logic (i.e., computer software) and/or data.

Computer system 1100 may also include one or more secondary storage devices or memory 1110. Secondary memory 1110 may include, for example, a hard disk drive 1112 and/or a removable storage device or drive 1114. Removable storage drive 1114 may be a floppy disk drive, a magnetic tape drive, a compact disk drive, an optical storage device, tape backup device, and/or any other storage device/drive.

Removable storage drive 1114 may interact with a removable storage unit 1116. Removable storage unit 1116 may include a computer usable or readable storage device having stored thereon computer software (control logic) and/or data. Removable storage unit 1116 may be a floppy disk, magnetic tape, compact disk, DVD, optical storage disk, and/any other computer data storage device. Removable storage drive 1114 may read from and/or write to removable storage unit 1116.

Secondary memory 1110 may include other means, devices, components, instrumentalities or other approaches for allowing computer programs and/or other instructions and/or data to be accessed by computer system 1100. Such means, devices, components, instrumentalities or other approaches may include, for example, a removable storage unit 1122 and an interface 1120. Examples of the removable storage unit 1122 and the interface 1120 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1100 may further include a communication or network interface 1124. Communication interface 1124 may enable computer system 1100 to communicate and interact with any combination of external devices, external networks, external entities, etc. (individually and collectively referenced by reference number 1128). For example, communication interface 1124 may allow computer system 1100 to communicate with external or remote devices 1128 over communications path 1126, which may be wired and/or wireless (or a combination thereof), and which may include any combination of LANs, WANs, the Internet, etc. Control logic and/or data may be transmitted to and from computer system 1100 via communication path 1126.

Computer system 1100 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1100 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1100 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML Customer Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1100, main memory 1108, secondary memory 1110, and removable storage units 1116 and 1122, as well as tangible articles of manufacture embodying any combination of the foregoing. Such control logic, when executed by one or more data processing devices (such as computer system 1100), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 11. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A computer-implemented method for a remote deposit environment, comprising:
associating categorization data with each of a plurality of images of financial instruments, the categorization data comprising at least one of a type of a financial instrument or an acceptability of the type of financial instrument depicted in an image of the plurality of images;
providing the plurality of images and the categorization data to an untrained or partially trained machine learning (ML) model as training data for training the untrained or partially trained ML model;
providing an image of a deposit financial instrument to the trained ML model;
receiving financial instrument type data in response to providing the image of the deposit financial instrument to the trained ML model, the financial instrument type data comprising at least one of a financial instrument type determination, a financial instrument type confidence score indicating a likelihood the financial instrument type determination is correct, a financial instrument type acceptability determination, or a financial instrument type acceptability confidence score indicating a likelihood the financial instrument type acceptability determination is correct; and
providing, in real-time via a display of a mobile device associated with a user, a document acceptance status related to acceptance of the image of the deposit financial instrument.

2. The method of claim 1, wherein the plurality of images comprises images of personal checks, business checks, cashier's checks, certified checks, traveler's checks, treasury checks, and money orders.

3. The method of claim 1, wherein the trained ML model is implemented on the mobile device.

4. The method of claim 3, wherein the untrained or partially trained ML model is trained using the training data on a remote platform and provided to the mobile device.

5. The method of claim 3, wherein the mobile device comprises a neural processing unit (NPU) to implement the trained ML model.

6. The method of claim 1, wherein the trained ML model is implemented on a remote platform.

7. The method of claim 1, the categorization data comprising an indication of whether the type of the financial instrument is acceptable or impermissible such that the financial instrument type data comprises the financial instrument type acceptability determination.

8. The method of claim 1, the financial instrument type data comprising the financial instrument type determination, wherein, in response to the financial instrument type determination corresponding to an impermissible financial instrument type, the document acceptance status indicates the impermissible financial instrument type is not accepted.

9. The method of claim 1, the financial instrument type data comprising the financial instrument type confidence score, wherein, in response to the financial instrument type confidence score being below a predetermined threshold, the document acceptance status indicates the image of the deposit financial instrument is not accepted.

10. The method of claim 9, wherein the document acceptance status further indicates the deposit financial instrument corresponds to no known financial instrument type.

11. The method of claim 1, the financial instrument type data comprising the financial instrument type acceptability confidence score, wherein, in response to the financial instrument type acceptability confidence score not meeting a predetermined threshold, the document acceptance status indicates the deposit financial instrument corresponds to an impermissible financial instrument type.

12. The method of claim 1, further comprising:
receiving a plurality of images of deposit financial instruments, each of the plurality of images of deposit financial instruments comprising an image of a financial instrument obtained using the mobile device associated with the user;
providing the plurality of images of deposit financial instruments to the trained ML model;
receiving financial instrument type data for each of the plurality of images of deposit financial instruments;
determining a financial instrument type parameter associated with the user, the financial instrument type parameter being based on the financial instrument type data for one or more of the plurality of images of deposit financial instruments;
identifying, based on financial instrument type data associated with the image of the deposit financial instrument, the financial instrument type parameter; and
based on the financial instrument type parameter, determining a confidence score associated with whether the image of the deposit financial instrument is fraudulent.

13. The method of claim 12, wherein the financial instrument type parameter comprises a number of financial instruments of a specific type attempted to be deposited within a time period.

14. The method of claim 1, further comprising:
in response to at least one of the financial instrument type determination or financial instrument type acceptability determination indicating the deposit financial instrument corresponds to an acceptable financial instrument type, providing the image of the deposit financial instrument and the financial instrument type determination to a validation system.

15. The method of claim 14, further comprising customizing a validation protocol based on the financial instrument type determination.

16. The method of claim 15, the customized validation protocol comprising verifying whether a feature of the deposit financial instrument corresponds to an expected feature.

17. The method of claim 15, further comprising providing feature location data to the validation protocol, the feature location data comprising a location of a feature and depending on the financial instrument type determination, wherein the customized validation protocol comprises directing an image analysis protocol to the location to obtain data related to the feature.

18. The method of claim 2, further comprising receiving the plurality of images, wherein the plurality of images have been submitted by a plurality of customers of a mobile banking app.

19. A system, comprising:
at least one memory; and
at least one processor coupled to the at least one memory and configured to:
associate categorization data with each of a plurality of images of documents, the categorization data comprising at least one of a type of a document or an acceptability of the type of document depicted in an image of the plurality of images;
provide the plurality of images and the categorization data to an untrained or partially trained machine learning (ML) model as training data for training the untrained or partially trained ML model;
provide an image of a user document to the trained ML model;
receive document type data in response to providing the image of the user document to the trained ML model, the document type data comprising at least one of a document type determination, a document type confidence score indicating a likelihood the document type determination is correct, a document type acceptability determination, or a document type acceptability confidence score indicating a likelihood the document type acceptability determination is correct; and
provide, in real-time via a display of a mobile device associated with a user, a document acceptance status related to acceptance of the image of the user document.

20. A non-transitory computer-readable device having instructions stored thereon that, when executed by at least one computing device, causes the at least one computing device to perform operations comprising:
associating categorization data with each of a plurality of images of documents, the categorization data comprising at least one of a type of a document or an acceptability of the type of document depicted in an image of the plurality of images;
providing the plurality of images and the categorization data to an untrained or partially trained machine learning (ML) model as training data for training the untrained or partially trained ML model;
providing an image of a user document to the trained ML model;
receiving document type data in response to providing the image of the user document to the trained ML model, the document type data comprising at least one of a document type determination, a document type confidence score indicating a likelihood the document type determination is correct, a document type acceptability determination, or a document type acceptability confidence score indicating a likelihood the document type acceptability determination is correct; and
providing, in real-time via a display of a mobile device associated with a user, a document acceptance status related to acceptance of the image of the user document.
